(19) United States
(12) Patent Application Publication
(10) Pub. No.: US 2026/0233412 A1
(43) Pub. Date: Aug. 13, 2026

(54) ROBOTIC END EFFECTOR SYSTEM

(71) Applicant: Chef Robotics, Inc, San Francisco, CA (US)

(72) Inventors: Tina Kao, San Francisco, CA (US); Rajat Bhageria, San Francisco, CA (US); Kody Brown, San Francisco, CA (US); Xinyi Daniel Tang, San Francisco, CA (US); Weston Wahl, San Francisco, CA (US); Clement Creusot, San Francisco, CA (US)

(73) Assignee: Chef Robotics, Inc., San Francisco, CA (US)

(21) Appl. No.: 19/637,976

(22) Filed: Apr. 2, 2026

Related U.S. Application Data
(63) Continuation-in-part of application No. 17/965,202, filed on Oct. 13, 2022.
(60) Provisional application No. 63/255,869, filed on Oct. 14, 2021.
(60) Provisional application No. 63/255,875, filed on Oct. 14, 2021.
(60) Provisional application No. 63/304,449, filed on Jan. 28, 2022.
(60) Provisional application No. 63/337,497, filed on May 2, 2022.

(51) Int. Cl. B25J 15/00; B25J 11/00

(52) U.S. Cl. CPC B25J 15/0033; B25J 11/0045; B25J 15/0028

(57) ABSTRACT

An end effector system can include: an optional actuator; an optional utensil mating connector; and a utensil. The utensil can include: a set of scoops; a set of mechanical linkages; a set of ingressive elements; and/or any other suitable components. However, the end effector system can additionally or alternatively include any other suitable set of components. The end effector system functions to facilitate picking of ingredients (e.g., foodstuffs), ingredient transformation, and/or ingredient insertion (e.g., at a target foodstuff container and/or placement location) via a grasp cavity of the utensil. Additionally or alternatively, the end effector system can function to shape a profile of ingredients (e.g., upon insertion). Additionally or alternatively, the end effector system can function to evacuate ingredients from the grasp cavity (e.g., clearing out ingredients adhering to the utensil).

### CROSS REFERENCE TO RELATED APPLICATIONS

This application is a continuation-in-part of U.S. application Ser. No. 17/965,202, filed 13 Oct. 2022, which claims the benefit of U.S. Provisional Application Ser. No. 63/337,497, filed 2 May 2022, U.S. Provisional Application Ser. No. 63/304,449, filed 28 Jan. 2022, U.S. Provisional Application Ser. No. 63/255,875, filed 14 Oct. 2021, and U.S. Provisional Application Ser. No. 63/255,869, filed 14 Oct. 2021, each of which is incorporated herein in its entirety by this reference.

U.S. Design Application Ser. No. 29/855,432, filed 3 Oct. 2022, is incorporated herein in its entirety by this reference.

### TECHNICAL FIELD

This invention relates generally to the food industry field, and more specifically to a new and useful robotic end effector system in the food industry field.

### BRIEF DESCRIPTION OF THE FIGURES

FIG. 1 is a schematic representation of a variant of the end effector system.

FIGS. 2A and 2B are schematic representations of a variant the end effector system in a first and second configuration, respectively.

FIG. 3 is an isometric view of a first variant of a utensil.

FIG. 4 is an isometric view of a second variant of a utensil.

FIG. 5 is an isometric view of a first variant of a utensil.

FIG. 6 is a partial 3D representation of a variant of an end effector.

FIG. 7 is a partial 3D representation of a variant of the end effector.

FIG. 8 is a partial 3D representation of a variant of the end effector.

FIG. 9 is a partial 3D representation of a variant of the end effector.

FIG. 10 is a partial 3D representation of a variant of the end effector system.

FIG. 11 is a partial 3D representation of a variant of the end effector.

FIG. 12A-12B illustrates a first and second example of extenders in a first and second variant of the end effector system, respectively.

FIG. 13 is a partial 3D representation of a variant of the end effector.

FIG. 14 includes images of a component in an example of the variant of end effector system shown in FIG. 13.

FIGS. 15A-15C are 3D views of an example of a utensil mating connector in a first, second, and third configuration, respectively.

FIG. 16 is a trimetric drawing of an example utensil mating connector with a tapered dovetail channel.

FIG. 17 is a 3D view of an example utensil mating connector with a tapered dovetail extrusion.

FIGS. 18A-18B illustrate a first and a second example of a variant of an end effector, respectively.

FIG. 19 is a partial 3D representation of a variant of an end effector.

FIG. 20A is an isometric view, from the front top left, of a first variant of a utensil in a grasp configuration.

FIG. 20B is an isometric view, from the back bottom right, of the first variant of a utensil in the grasp configuration.

FIG. 21A is an isometric view, from the front top left, of a first variant of a utensil in the anti-grasp configuration.

FIG. 21B is an isometric view, from the back bottom right, of the first variant of a utensil in the anti-grasp configuration.

FIG. 22A is an isometric view, from the front top left, of a first variant of a scoop, integrated with a set of ingressive elements.

FIG. 22B is an isometric view, from the back bottom right, of the first variant of a scoop, integrated with a set of ingressive elements.

FIG. 22C is an elevation view from the left of the first variant of a scoop, integrated with a set of ingressive elements.

FIG. 22D is an elevation view from the right of the first variant of a scoop, integrated with a set of ingressive elements.

FIG. 22E is a plan view from the top of the first variant of a scoop, integrated with a set of ingressive elements.

FIG. 22F is a plan view from the bottom of the first variant of a scoop, integrated with a set of ingressive elements.

FIG. 22G is an elevation view from the back of the first variant of a scoop, integrated with a set of ingressive elements.

FIG. 22H is an elevation view from the front of the first variant of a scoop, integrated with a set of ingressive elements.

FIGS. 23A-23B are isometric views, from the front top left and back bottom right, respectively, of a first variant of a utensil extender.

FIGS. 23C-23D are plan views, from the top and bottom, respectively, of the first variant of the utensil extender.

FIGS. 24A-24B are elevation views from the front of a variant of a utensil in a first and second configuration, respectively.

FIGS. 25A-25B are elevation views from the front of a variant of a utensil in a first and second configuration, respectively, illustrating the set of mechanical linkages.

FIGS. 25C-25E are a first, second, and third diagrammatic example, respectively, illustrating mechanical linkages in the first and second configurations.

FIGS. 26A and 26B are 3D views of a variant of the utensil in a first and second configuration, respectively.

FIGS. 27A and 27B are 3D views of a variant of the utensil in a first and second configuration, respectively.

FIG. 28 is a partial 3D representation of a variant of an end effector.

FIG. 29 is an elevation view from the left of the first variant of a scoop, integrated with a set of ingressive elements.

FIG. 30 is an isometric view, from the front top left, of a first variant of a utensil in the anti-grasp configuration.

FIGS. 31A-31B are top-down views of a variant of a shielded utensil with a clamshell shape.

FIGS. 32A-32B are bottom-up views of a variant of a shielded utensil with a clamshell shape.

FIGS. 33A-33D are views of a variant of a shielded utensil body with a clamshell shape.

FIGS. 34A-34B are views of a variant of a shielded utensil with clamshell shape.

FIGS. 35A-35B are views of a variant of a shielded utensil with a clamshell shape.

FIGS. 36A-36B are top-down views of a variant of a shielded utensil with a bucket-style shape.

FIGS. 37A-37B are bottom-up views of a variant of a shielded utensil with a bucket-style shape.

FIGS. 38A-38D are views of a variant of a shielded utensil with bucket-style shape.

FIGS. 39A-39B are views of a variant of a shielded utensil with a bucket-style shape.

FIGS. 40A-40B are views of a variant of a shielded utensil body with a bucket-style shape.

FIG. 41 is a schematic representation of a variant of a scoop.

FIGS. 42A-42C are top-down schematics of a variant of a utensil and a scoop.

FIGS. 43A-43D are a first perspective view, a second perspective view, a top view, and a front view of a variant of a shield.

FIGS. 44A-44B are perspective views of a first and a second configuration of a variant of a shield.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

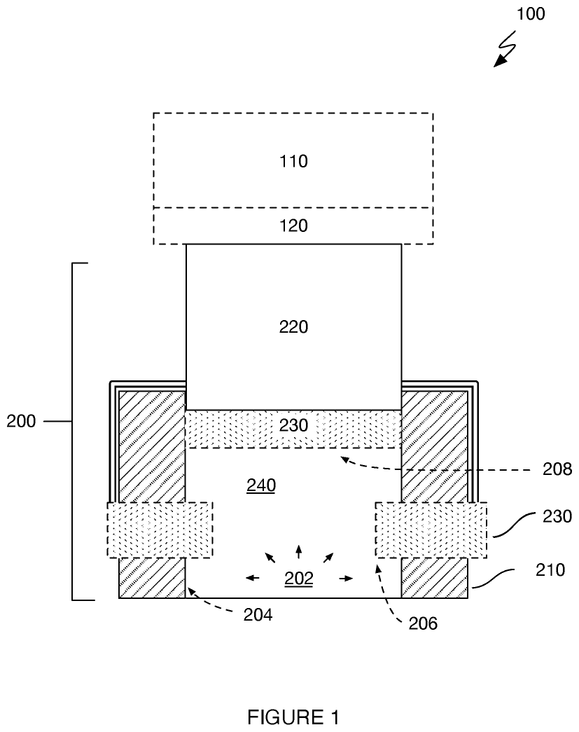

The end effector system 100, an example of which is shown in FIG. 1, can include: an optional actuator 110; an optional utensil mating connector 120; and a utensil 200. The utensil can include: a set of scoops 210; a set of mechanical linkages 220; a set of ingressive elements 230; a set of shields 240 and/or any other suitable components. However, the end effector system 100 can additionally or alternatively include any other suitable set of components. The end effector system functions to facilitate ingredient (e.g., foodstuffs) manipulation, ingredient picking, ingredient transformation, and/or ingredient insertion (e.g., at a target foodstuff container and/or placement location) via a grasp cavity of the utensil. Additionally or alternatively, the end effector system can function to shape a profile of ingredients (e.g., upon insertion). Additionally or alternatively, the end effector system can function to evacuate ingredients from the grasp cavity (e.g., clearing out ingredients adhering to the utensil).

The system can optionally include or be used in conjunction with a robotic assembly system, such as a robotic pick and place system, gantry-style assembly system, multi-axis robotic arm, and/or other robotic assembly system. In variants, the system can be used in conjunction with the robotic assembly system and/or method as described in U.S. application Ser. No. 17/881,475, filed 4 Aug. 2022, which is incorporated herein in its entirety by this reference.

In a first set of variants, system optionally include or be used in conjunction with an industrial conveyor line, or can be deployed in a high-throughput assembly application (e.g., airline food catering prep, etc.), such as in place of a human line worker and a manually-operated utensil. However, the system can alternatively be deployed in any suitable robotic assembly settings. In a second set of variants, the end effector system can be implemented in a restaurant setting, such as a ‘fast casual’, ‘ghost kitchen’ or low-throughput application (e.g., without continuous operation; universities, K-12, prisons, hotels, hospitals, factories, stadiums, entertainment venues, festivals, etc.).

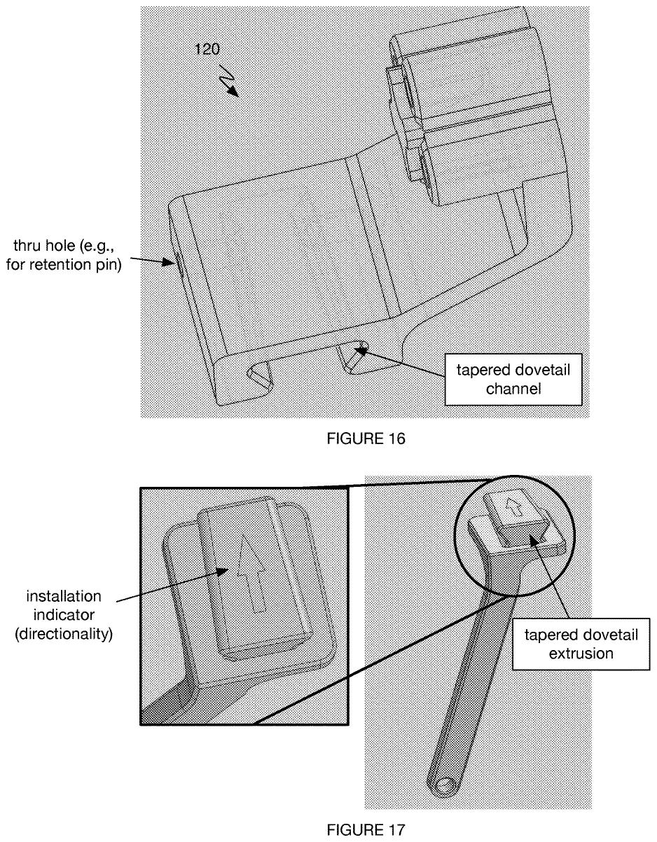

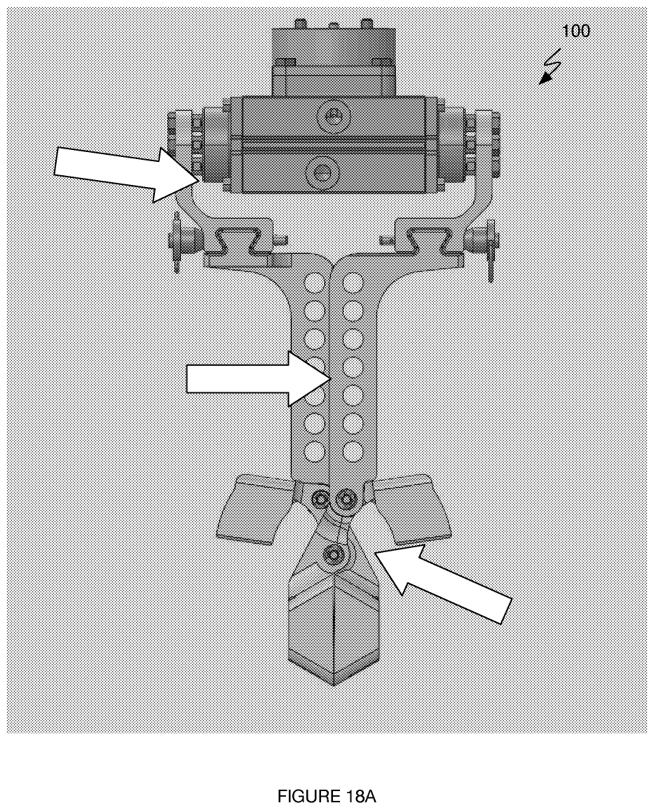

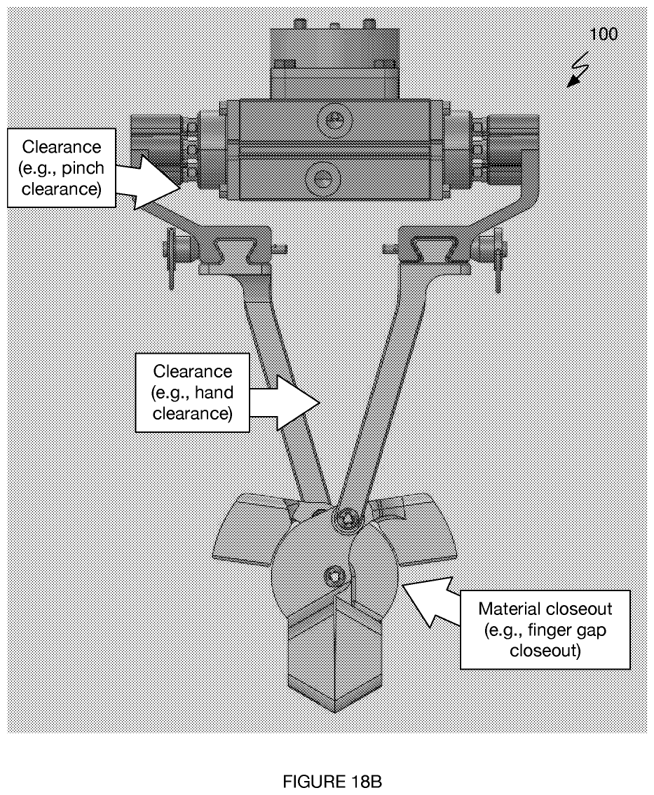

In some variants (e.g., such as in the example shown in FIG. 18A), utensils can be connected with a utensil mating connector which includes a dovetail joint. In variants (e.g., such as in the examples shown in FIG. 16 and FIG. 17) the utensil mating connector can include a tapered (sliding) dovetail joint. In variants (e.g., such as in the example shown in FIG. 18B), the end effector system can include closeouts and/or clearances to eliminate pinch points around the utensil, utensil mating connector actuator, and/or any linkages thereof. In some variants, the utensils and/or utensil mating connector can include human identifiable indicators (e.g., indicating assembly directionality; indicating compatibility; indicating size, etc.; such as in the example shown in FIG. 17).

The term “color distance” as utilized herein can refer to the color distance D which is calculated in terms of RGB values by the equation D²=R²+G²+B² or, similarly, D=\sqrt{R²+G²+B²}, where R, G, and B respectively refer to the differences in red, green, and blue values of two colors. For example, the color distance between a first color with RGB values R1, G2, and B1 and a second color with RGB values R2, G2, and B2, the color distance between the first and second colors can be calculated as: D=\sqrt{(R2−R1)²+(G2−G1)²+(B2−B1)²}. However, the color distance can be otherwise calculated and/or defined. Likewise, a “minimum color distance” can be understood to mean a minimum value for the color distance/separation between two colors or color ranges. However, the minimum color distance can be otherwise defined.

As used herein, the “separation plane” 400 refers to a plane containing the revolute axis 300 and oriented to pass between opposing grasp surfaces of the scoops 210 when the utensil is in the grasp configuration. For a utensil with a pair of opposing scoops that close symmetrically about the revolute axis, the separation plane is preferably defined as the plane containing the revolute axis and passing through a centroid of the interface between the opposing grasp surfaces in the grasp configuration (e.g., a centroid of the distal edge along which the grasp surfaces meet or most closely approach one another). In an example, for a utensil with scoops whose grasp surfaces meet along a substantially linear distal edge in the grasp configuration, the separation plane contains both the revolute axis 300 and that distal edge. Alternatively, the separation plane can be defined as any plane containing the revolute axis that bisects the grasp cavity 202 into two substantially equal volumes when the utensil is in the grasp configuration, and/or as a plane substantially perpendicular to a direction of scoop closure (e.g., a direction along which the grasp surfaces translate or rotate toward one another during transformation from an anti-grasp configuration to the grasp configuration). Proximal portions of the scoops (e.g., portions adjacent to or intersecting the revolute axis, mounting features, linkage interfaces) can extend across the separation plane; accordingly, the separation plane is defined with respect to the grasp cavity and grasp surfaces rather than the entirety of each scoop body. The designation of “left” and “right” scoops is arbitrary and is used herein solely to distinguish opposing scoops relative to the separation plane; the utensil need not exhibit bilateral mirror symmetry about the separation plane, and the left and right scoops can be symmetric, substantially symmetric, or asymmetric relative to the separation plane. However, the separation plane can be otherwise suitably defined.

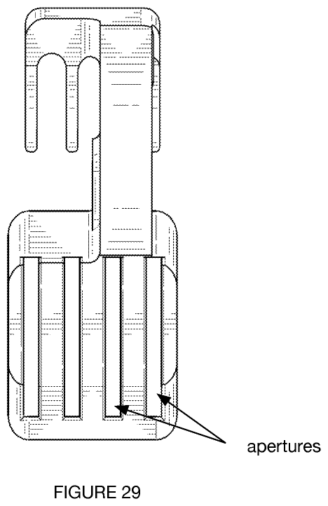

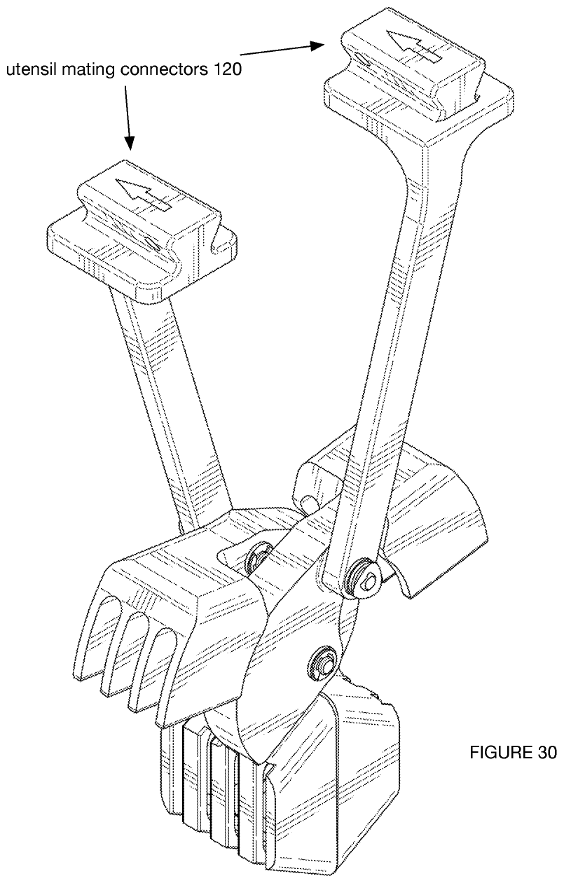

As used herein “lateral direction” or “laterally” refers to directions substantially parallel to the separation plane 400 and/or revolute axis 300. A “lateral side” of the grasp cavity refers to sides bounded by surfaces with normal vectors substantially oriented towards an opposing lateral side (i.e., parallel to the separation plane). In a variant, the revolute axis is laterally aligned (e.g., examples shown in FIGS. 29A and 29B).

### 1.1 Illustrative Examples.

In a first set of variants, a robotic end effector system for aggregate manipulation of foodstuff can include: an actuator configured to mount to a distal end of a robotic arm; and a foodstuff utensil mounted to the actuator, which includes: a plurality of scoops, each including a respective grasp cavity and a defining set of apertures; a set of mechanical linkages coupling the plurality of scoops to the actuator and configured to transition the plurality of scoops between a grasp configuration and an anti-grasp configuration based on a mechanical actuation input from the actuator, wherein, in the grasp configuration, the plurality of scoops cooperatively defines a grasp volume within an interior of the respective grasp cavities of the plurality of scoops; and a set of ingressive elements, each ingressive element of the set aligned with a respective aperture, wherein, in the grasp configuration, each ingressive element is outside of the grasp volume, wherein, in the anti-grasp configuration, each of the ingressive elements ingress into the interior of the respective grasp cavity through the aperture.

In a second set of variants, nonexclusive with the first set, a foodstuff utensil which is configured to mount to an actuator of a robot for aggregate manipulation of foodstuff can include: a set of utensil mating connectors; a set of scoops, each including a grasp cavity and a defining set of apertures; a set of ingressive elements, each ingressive element aligned with a respective aperture of a corresponding scoop; a set of mechanical linkages coupling the set of scoops to the set of utensil mating connectors, wherein the set of mechanical linkages is configured to transform the set of scoops between a first and second configuration based on an actuation of the set of utensil mating connectors, wherein, in the first configuration, each ingressive element is outside of an interior grasp volume of each grasp cavity, wherein, in the second configuration, each of the ingressive elements ingress the corresponding scoop through the respective aperture.

In a third set of variants, nonexclusive with the first and second sets, a foodstuff utensil can include a pair of scoops, each scoop of the pair comprising: a grasp surface, a lip at a distal end of the grasp surface, and a side shield; as well as a mechanical linkage comprising a revolute joint, the mechanical linkage configured to transform the scoops between a first and second configuration in which the lips are separated from each other and proximate to each other, respectively, wherein each grasp surface is between both side shields of the pair of scoops, wherein each lip extends between the side shields in both the first and second configurations.

In variants, the side shield of each scoop is substantially planar and defines an interior plane, at a proximal end of the lip, which is orthogonal to a revolute axis of the revolute joint. In one example, foodstuff utensil can the utensil of the first example, wherein each lip contacts both side shields of the pair of scoops in the first and second configurations and all liminal arrangements therebetween. In a second example, the first configuration and second configuration are at opposing ends of an actuation stroke of the mechanical linkage, which opens and closes the pair of scoops in the first and second configurations, respectively.

In variants, each scoop comprises a polyoxymethylene polymer and is configured to slide along the side shield of the other scoop of the pair during transformation of the utensil between the first configuration and the second configuration.

In variants, a side shield of a first scoop of the pair is configured to maintain a fixed distance from a second scoop of the pair throughout an actuation stroke of the mechanical linkage. For example, the fixed distance can be zero with the side shield of the first scoop abutting the second scoop.

In variants, the side shield of the second scoop is parallel with the side shield of a first scoop of the pair and is separated from the side shield of the first scoop of the pair across a grasp cavity defined between the grasp surfaces.

In variants, in the first configuration, the grasp surface of a first scoop of the pair, side shield of the first scoop, the grasp surface of a second scoop of the pair, and side shield of the second scoop constrain foodstuff from exiting the grasp cavity.

In variants, the side shields are imperforate (e.g., with each scoop perforate proximal to the lip, such as to allow ingress via an ingressive element).

In variants, a first scoop of the pair is configured to rotate relative to a second scoop of the pair about the revolute joint.

In a fourth set of variants, nonexclusive with the first, second, and third sets, a foodstuff utensil can be configured to manipulate foodstuff by articulation between an open configuration and a closed configuration. In this example, the foodstuff utensil can include a first and second scoop hinged about a revolute joint, the first and second scoop cooperatively defining a grasp cavity, in the open configuration, between a first interior of the first scoop and a second interior of the second scoop, wherein a first and a second lip of the first and second scoops, respectively, are separated in the open configuration and distal from the revolute joint; and a left shield arranged along a left side of the grasp cavity, wherein the left shield is adjacent to both the first and second lips in the open configuration.

The foodstuff utensil can additionally include a right shield connected to the second scoop and arranged opposite the left shield across the grasp cavity, wherein the right shield is adjacent to both the first and second lips in the open configuration. In one example, the first scoop and left shield are integrated into a unitary body.

In variants, the left shield is tapered at a distal end relative to the revolute joint.

In variants, a distal end of the left shield is arcuate.

In variants, the left shield spans an annular sector about the revolute joint, the annular sector bounded, in a reference plane, by the first and second scoops in the open configuration. In one example, the first scoop comprises a scraper arm, wherein the left shield extends from the first interior to the scraper arm, wherein the scraper arm is configured to scrape along the second interior throughout the articulation between the open and closed configurations. In one variation, the first scoop, scraper arm, and left shield are integrated into a unitary body.

### 2. Benefits

Variations of the technology can afford several benefits and/or advantages.

First, variations of this technology can be utilized in a robotic assembly architecture to flexibly adapt to a variety of food assembly applications. Variants of the system can utilize interchangeable food utensils to accommodate different types of ingredients (e.g., with different materials properties, such as different: textures, packing density, shape, compressibility/deformability, etc.; where the utensil form factor may allow for shipping the utensil by mail, such as in a small or medium flat rate USPS box, to facilitate rapid ingredient onboarding) and/or different quantities of ingredients during assembly.

Second, variations of this technology can facilitate placement of sticky (e.g., viscoelastic), malleable, and/or partially frozen ingredients-which have a tendency to cause ingredient buildup on end-effector surfaces after many placement cycles. Variations of this technology can limit ingredient buildup and facilitate continuous operation (e.g., without manual servicing, tool replacement, cleaning, etc.) even after many cycles (e.g., 10, 100, 1k, 10k, 20k, 30k, 50k, 100k, more than 100k, any range bounded by the aforementioned values, etc.). Limiting ingredient buildup can additionally increase consistency of food assembly (e.g., when compared to a human or a dispensing system) and/or can ensure high accuracy (e.g., mass/volume/quantity within a threshold tolerance, such as within 10% of a predetermined amount) and repeatability (e.g., minimal variability across different robotic arms, particularly when compared to different human users) of placed food amounts, which can provide cost savings (e.g., minimizing excess food provisions; increase yield) and reduce food waste/spillage. In variants, utensils can be passively actuated (e.g., without requiring a communicative connection), which can allow the utensil to be dish washed or placed into a clean-out-of-place (COP) solution.

Third, variations of this technology can include utensil surfaces which can be used to shape ingredients within a foodstuff container for repeatable placement and/or packing arrangements (e.g., millimeter accuracy, gram mass accuracy, etc.), which can improve aesthetics of assembly and/or conformance to a specific foodstuff arrangement.

Fourth, variations of this technology can reduce or mitigate user safety risks in a collaborative robotic setting (e.g., where humans may work side by side with the robot and perform various manual servicing operations adjacent to and/or within a task space of the robot). For example, variants can include closeouts, increased material volume, and/or clearance/offsets to reduce or eliminate pinch points (e.g., wrist, finger, etc.; an example is shown in FIGS. 18A-B)

Fifth, variants of this technology can improve the precision of insertion within a foodstuff container, as well as morphometric consistency of picked foodstuffs. The usage of shields on lateral sides of the grasp cavity (e.g., perpendicular to grasp surfaces) can constrain lateral motion of foodstuff within the grasp cavity (e.g., during picking/insertion operations) and reduce or eliminate lateral spillage of ingredients during grasping and insertion operations. By laterally enclosing the grasp cavity, the shield can maintain ingredient containment even during dynamic robotic motions (e.g., rapid acceleration, jiggling, shaking) that might otherwise cause ingredients to escape from the sides of the scoops. The shield can enable reliable picking of ingredients with high lateral flow characteristics (e.g., small particulates, liquids, semi-liquids, granular materials such as rice or quinoa, fine powders) that would otherwise flow out between the scoops during actuation, particularly at the beginning of an insertion operation (e.g., where the gap between scoops is small). In variants of the technology in which the foodstuffs picked by the utensil are large, the shields can reduce the risk of a large foodstuff item outside the grasp cavity being lifted upward after being pinched between the scoops. The sliding interface between the shield and the opposing scoop can provide a self-cleaning action, wherein the opposing scoop scrapes adherent ingredients from an interior shield surface during each actuation cycle, reducing buildup and maintaining picking performance over many cycles (e.g., 10, 100, 1 k, 10 k, 20 k, 30 k, 50 k, 100 k, more than 100 k cycles). The shield can protect the grasp cavity from cross-contamination with adjacent ingredients in multi-bin picking scenarios, particularly when the utensil must traverse laterally over other ingredient bins to reach a target location.

Sixth, variations of the shield can reduce or eliminate lateral spillage of ingredients during grasping and insertion operations. By laterally enclosing the grasp cavity, the shield can maintain ingredient containment even during dynamic robotic motions (e.g., rapid acceleration, jiggling, shaking) that might otherwise cause ingredients to escape from the sides of the scoops. The shield can enable reliable picking of ingredients with high lateral flow characteristics (e.g., small particulates, liquids, semi-liquids, granular materials such as rice or quinoa, fine powders) that would otherwise flow out between the scoops during actuation. The sliding interface between the shield and the opposing scoop can provide a self-cleaning action, wherein the opposing scoop scrapes adherent ingredients from the interior shield surface during each actuation cycle, reducing buildup and maintaining picking performance over many cycles (e.g., 10, 100, 1 k, 10 k, 20 k, 30 k, 50 k, 100 k, more than 100 k cycles). The shield can protect the grasp cavity from cross-contamination with adjacent ingredients in multi-bin picking scenarios, particularly when the utensil must traverse laterally over other ingredient bins to reach a target location.

Seventh, variations of the technology can use a shield edge feature (e.g., a taper) to reduce insertion forces required to penetrate the shield into a bed of ingredients, which can reduce actuator load, extend actuator lifespan, and/or enable faster picking cycle times. The taper can minimize compression and deformation of ingredients during insertion, which can be particularly beneficial for delicate ingredients (e.g., leafy greens, berries, cooked pasta, shredded cheese) that may be damaged by blunt-edge insertion. By parting or displacing ingredients rather than crushing them, the tapered edge can maintain ingredient quality and visual appeal. The cutting action of the taper can sever adhesive bonds between ingredient particles (e.g., frozen conglomerates, sticky ingredients) or separate ingredients from container walls, facilitating cleaner picks with less residual material. The taper can reduce ingredient adhesion to the distal edge of the shield, which can minimize cleaning requirements and reduce cross-contamination between different picking operations.

However, variations of the technology can additionally or alternately provide any other suitable benefits and/or advantages.

### 3. End Effector System

The end effector system 100, an example of which is shown in FIG. 1, can include: an optional actuator 110; an optional utensil mating connector 120; and a utensil 200. The utensil can include: a set of scoops 210; a set of mechanical linkages 220; a set of ingressive elements 230; a set of shields 240; and/or any other suitable components. However, the end effector system 100 can additionally or alternatively include any other suitable set of components. The end effector system functions to facilitate ingredient (e.g., foodstuffs) manipulation, ingredient picking, ingredient transformation, and/or ingredient insertion (e.g., at a target foodstuff container and/or placement location) via a grasp cavity of the utensil. Additionally or alternatively, the end effector system can function to shape a profile of ingredients (e.g., upon insertion). Additionally or alternatively, the end effector system can function to evacuate ingredients from the grasp cavity (e.g., clearing out ingredients adhering to the utensil).

The end effector system and/or an actuator thereof is preferably configured to mount to a distal end of a robotic assembly system, such as a robotic pick and place system, gantry-style assembly system, multi-axis robotic arm, and/or other robotic assembly system. In variants, the system can be used in conjunction with the robotic assembly system and/or method as described in U.S. application Ser. No. 17/881,475, filed 4 Aug. 2022, which is incorporated herein in its entirety by this reference. In an example, the end effector and/or actuator are configured to mount to a distal end of a robotic arm (e.g., multi-axis robotic arm; collaborative robotic arm; etc.). However, the end effector system 100 can be configured to operate with any other suitable robotic system and/or in any other suitable robotic assembly context.

In variants, the end effector system and/or each component thereof (e.g., utensil) can be configured to be individually or collectively certified in compliance with various food industry standards (e.g., NSF food safety standards; food safe), and/or may otherwise be considered ‘food safe’. For example, variants can include or be utilized in conjunction with NSF H1 food safe grease (e.g., at each revolute joint) and/or food safe epoxy (e.g., to seal/cover an external opening/cavity, etc.). Additionally or alternatively, variants may be utilized outside of food applications and/or in various alternative contexts without food safety requirements/standards; and/or may be otherwise configured.

In variants, the end effector system and/or each component thereof (e.g., utensil) can be configured to be individually or collectively certified in compliance with various ingress protection standards (e.g., IP65; IP67; IP67+; etc.). However, variants may be utilized outside of industrial applications and/or in various alternative contexts without certified compliance with ingress protection requirements/standards; and/or may be otherwise configured.

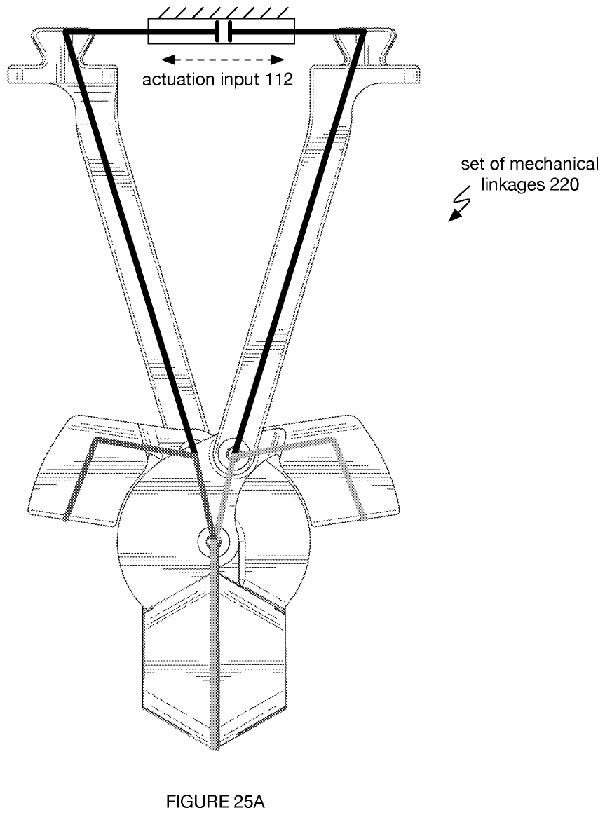

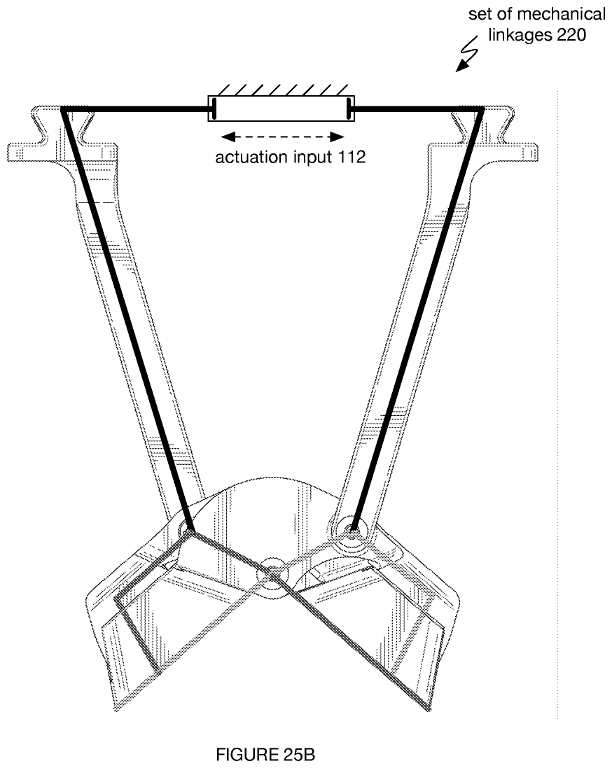

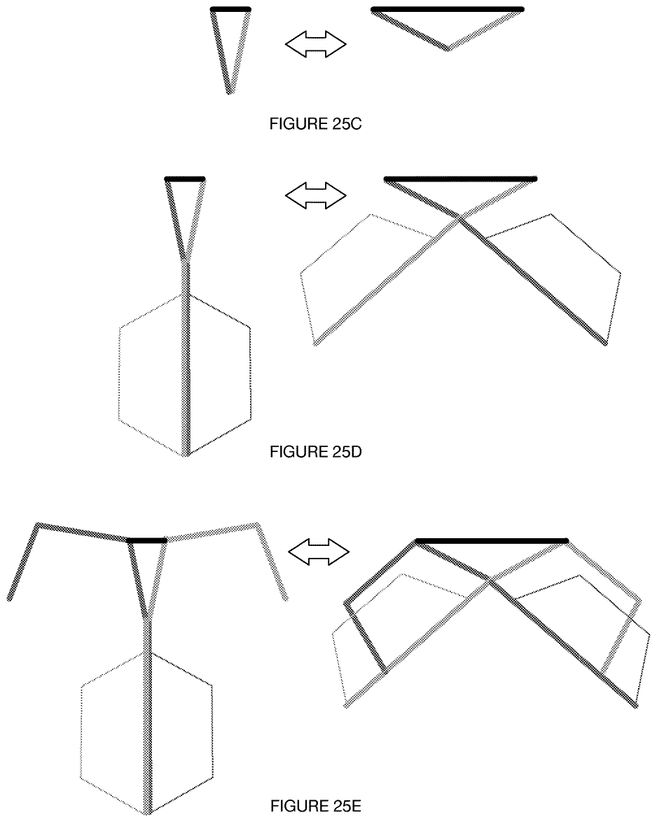

The end effector can optionally include an actuator 110 which functions to provide an actuation input to the set of mechanical linkages to transform the scoops and/or grasp cavity (and/or foodstuff ingredients housed therein). The actuator is preferably mounted to the terminal end of a robotic assembly system (e.g., wrist of a multi-axis robot arm; final stage of a gantry system; etc.) and/or integrated into a robotic assembly system, but can be otherwise implemented. The actuator can be powered: electrically (e.g., servo or motor actuation), pneumatically, hydraulically, and/or otherwise suitably powered. The actuation input provided by the actuator can be linear, rotational, or a combination thereof. The actuator can act in a single direction (e.g., with an opposing spring-loaded return; single acting) or bi-directionally (e.g., powered in both directions along an actuation axis; double acting). The actuator can have a single actuation end (e.g., with an opposing end fixedly mounted) or two actuation ends (e.g., actuating in opposite directions and centrally mounted between the actuation ends; an example is shown in FIGS. 25A and 25B). As an example, the actuator can be a linear actuator (e.g., providing a linear actuation stroke as an actuation input). As a second example, the actuator can be an electric motor (e.g., providing a rotational actuation as an input and/or a combined rotation/translation as an actuation input). In variants, the end effector can be a rotary end effector, an angular end effector, and/or any other suitable end effector with any other suitable actuation.

The actuator can be communicatively coupled to a robot controller (e.g., electrical communication; fluid communication; etc.) and/or powered by a robot controller or other robotic control system. In variants, the actuator can be a pneumatic actuator driven by a pneumatic pressure within a pneumatic actuation line (e.g., selectively coupled to a pressurized chamber with electronically actuated valves, such as solenoid valves, controlled with the controller). In such variants, the pneumatic line pressure and/or chamber pressure coupled thereto can be controlled, uncontrolled, static, dynamic, and/or pneumatic actuators can be otherwise actuated. For example, in variants, the actuator can actuate the utensil with an input force corresponding to a grasp force (e.g., at a distal end of the scoop) and/or grasp moment based on the pressure of the pneumatic line and/or pressurized chamber. Accordingly, grasp forces/moments can be controlled (e.g., by controlling the pneumatic pressure), dynamic (e.g., based on a dynamic pressure changes of the pneumatic line), predetermined (e.g., based on a manual setting at an HMI and/or a predetermined configuration of a robotic assembly system), static, varied, indirectly controlled, uncontrolled (e.g., not directly controlled), and/or otherwise implemented. In an example, a grasp moment can be a moment of about a hinge axis of a scoop. In a second example, a grasp force can be the force at a distal end of a scoop. In a third example, a grasp force can be the force between a scoop and foodstuffs at a contact point. However, the actuator can be otherwise suitably actuated.

In variants, the actuator (and/or the robot supporting the actuator) can optionally be housed within and/or contained by a suit (a.k.a. jacket) which functions to enable cleaning and/or functions to protect actuator from particulate ingress or soiling. The suit can be disposable (e.g., enabling cleaning by replacement of the suit), removable (e.g., manually removed for cleaning, such as via a machine wash), and/or cleanable by wipe down and/or wash down processes. The suit can be sealed against the robot, meeting or exceeding IP67 standards (e.g., separating the enclosed volume of the suit from the utensil), but can be otherwise suitably implemented. As an example, the actuator can be enclosed by a single suit which is formed with heat welded or sonically welded seams. However, the actuator can otherwise be unenclosed (e.g., designed to satisfy food compatibility and/or ingress protection standards; such as IP67 and/or NSF food safety compliance standards) and/or used without a suit or covering (e.g., such as in secondary applications, line operations which do not involve food, etc.).

However, the system can otherwise include or be used in conjunction with any other suitable actuator; or can otherwise altogether exclude an actuator.

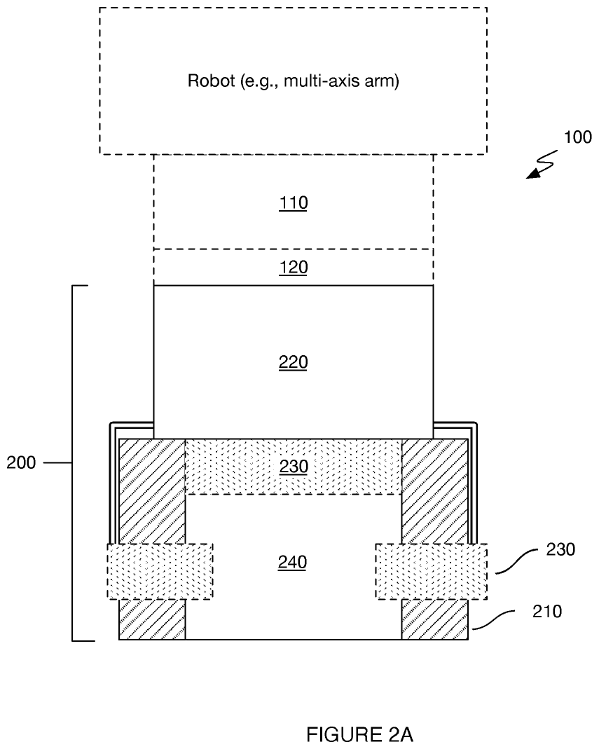

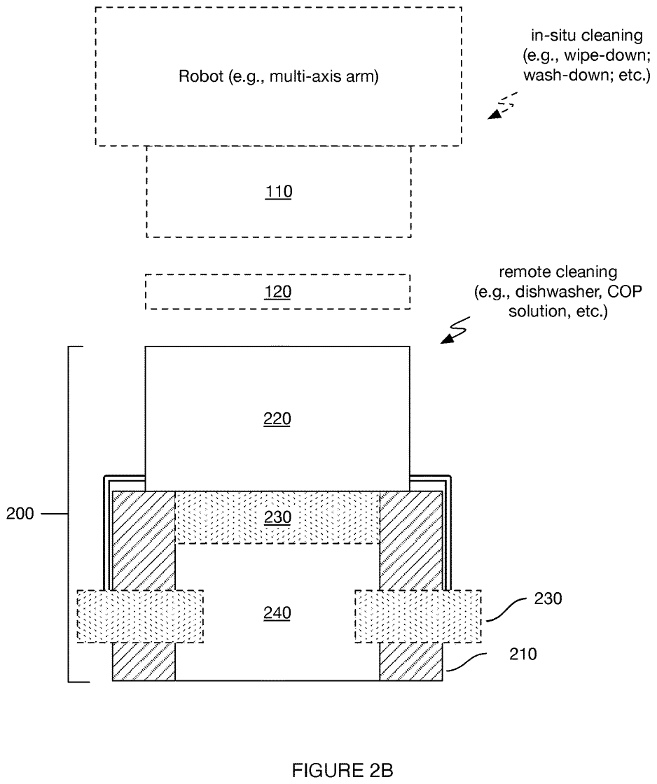

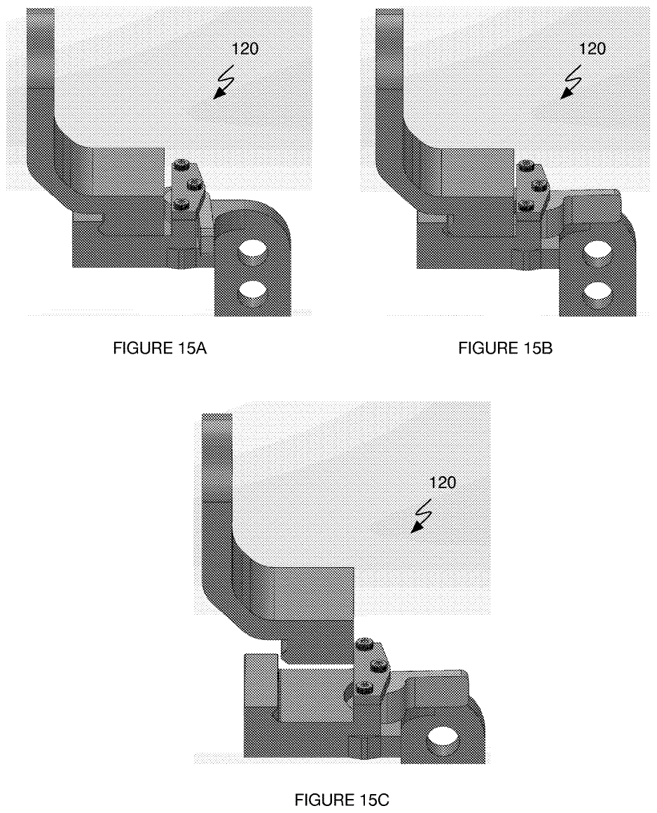

The end effector can optionally include a utensil mating connector(s) 120 which functions to mount the utensil to the actuator along a mating interface. Additionally or alternatively, the utensil mating connector can function to transfer forces/moments between the set of mechanical linkages and the actuator (e.g., actuating ends thereof). Additionally or alternatively, the utensil mating connector(s) can function to facilitate utensils to be interchangeably swapped (e.g., for ingredient-specific utensils and/or utensils to be swapped based on a desired pick amount) and/or removed (e.g., to facilitate remote/dishwasher cleaning; example configurations are shown in FIGS. 2A and 2B; examples configurations are shown in FIGS. 15A-C).

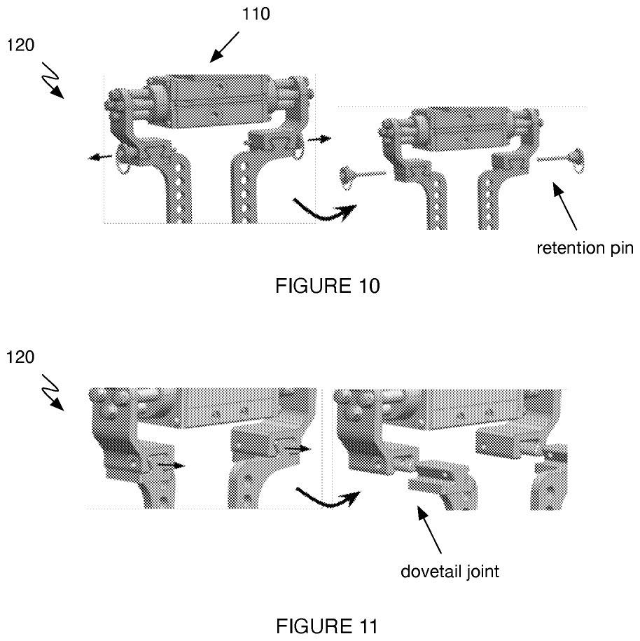

The utensil mating connector preferably defines a mating interface (e.g., an example is shown in FIGS. 10 and 11; pair of opposing bearing surfaces in contact), which may facilitate attachment and/or removal of the utensil. More preferably, the mating interface preferably facilitates a tool-less, quick removal (quick-release) and/or attachment. In order to facilitate the quick attachment and detachment of utensils from the robotic system in the field for the cleaning of used utensils or for switching to another utensil for a different ingredient, tool-less mechanisms can be changed quickly by hand. More preferably, the mating connector is configured to maintain a tight/substantially-rigid interface between the fingers and components attached to the gripper, so that the motions of the utensil can be precisely controlled by the gripper without any backlash (e.g., less than 0.1 deg angular backlash, less than 0.2 mm, less than 0.05 mm, less than 0.02 mm, zero backlash, etc.). For example, the mating interface can be a linear plain bearing slide (e.g., dovetail, boxway, bushing, etc.) or rotational interface (e.g., cam lock, screw, conic interface, etc.). The mating interface can be secured manually (e.g., pinned), automatically (e.g., by a pneumatic collar, by an electromechanical or magnetic retention mechanism; by a passive retention spring; etc.), actively, passively, and/or via any other suitable fasteners or retention features. As an example, the mating interface can be secured by way of a snap-fit, mechanical quick-disconnect, ball-latching interface, pinned interface (e.g., an example is shown in FIG. 10), and/or any other suitable retention mechanism(s).

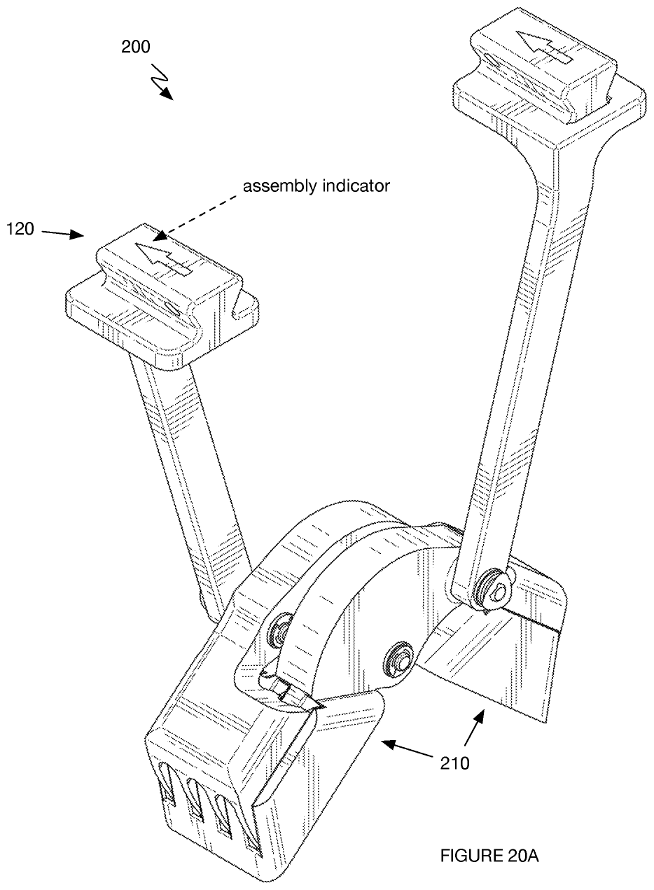

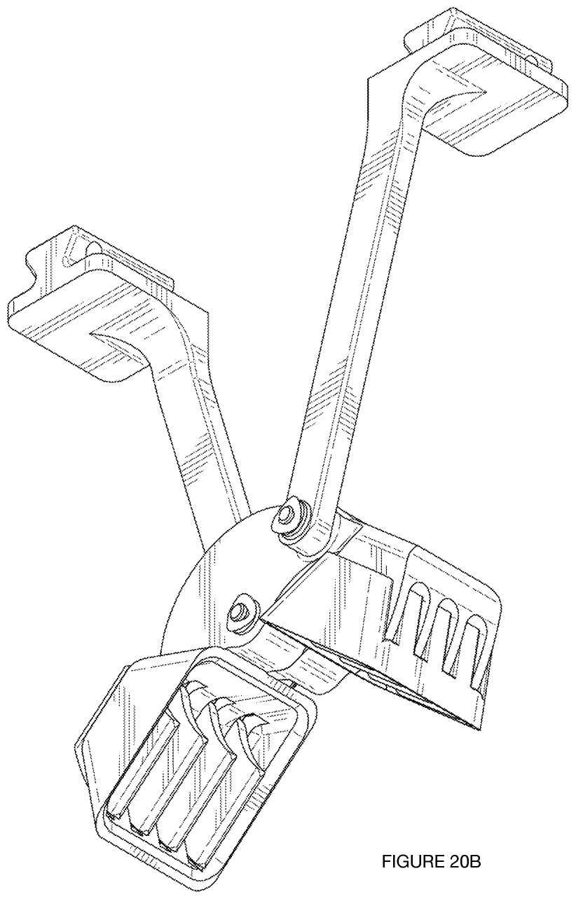

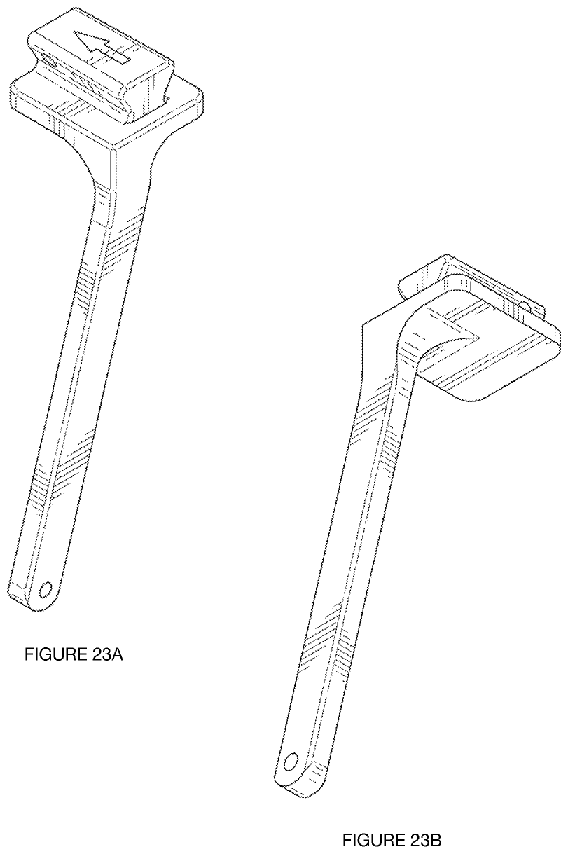

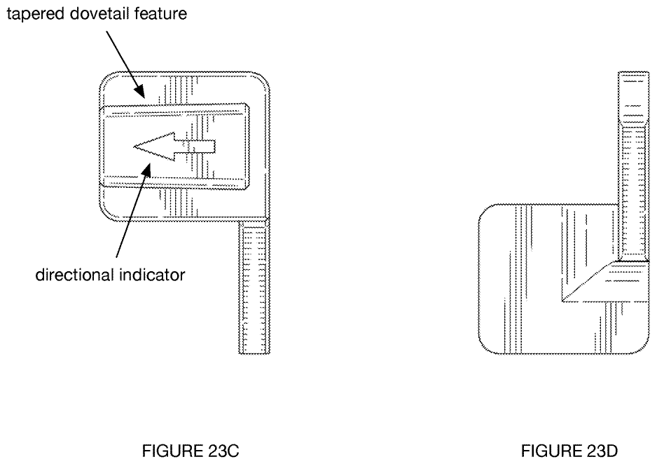

In one variant, the utensil mating connector(s) can include a tapered dovetail connection(s), an example of which is shown in FIG. 23C. A slight taper angle (e.g., 0.5 degrees to 2 degrees; 1 degree taper) and a tight manufacturing tolerance (e.g., tolerance of 0.02 mm or less, etc.) may increase overall rigidity and assembly robustness. For example, tapered connections, particularly when used in conjunction with manual assembly indicators (e.g., arrows, assembly indicator markings, etc.; examples are shown in FIGS. 20A, 21A, and 23C) may yoke the system by eliminating possibility of incorrect/unintended assembly configurations which are visually similar to the nominal assembled configuration (e.g., particularly when elements have a high degree of symmetry). Additionally or alternatively, the tapered dovetail may eliminate assembly symmetry of the system (e.g., where there is exactly one assembly direction/configuration). Tapered dovetails can be manufactured by wire EDM or another material removal manufacturing process (e.g., CNC milling, etc.), but can be otherwise formed/fabricated.

In variants, such quick-change mechanisms may allow the same actuator (and/or robot) to be efficiently used with different utensils and, accordingly, allow the same actuator to manipulate different ingredients, pick different portion sizes, and/or place at different endpoints.

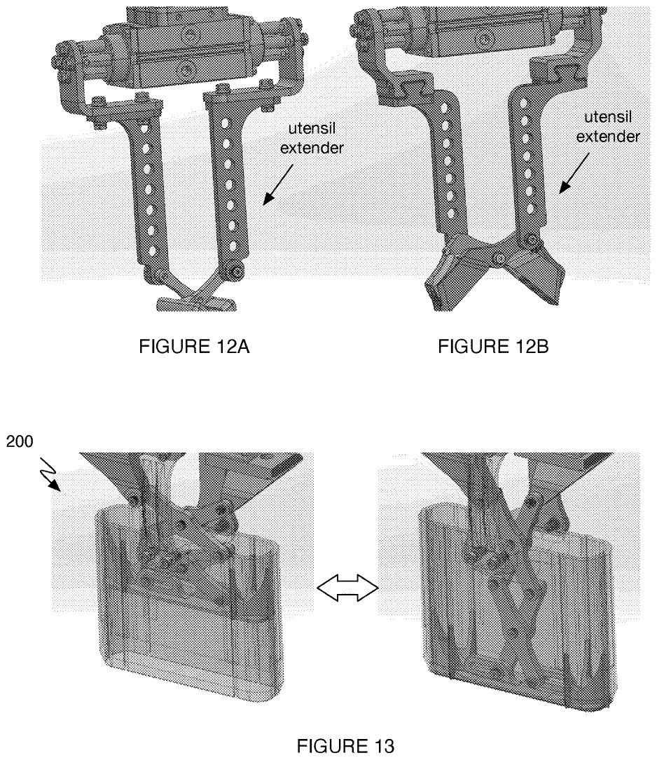

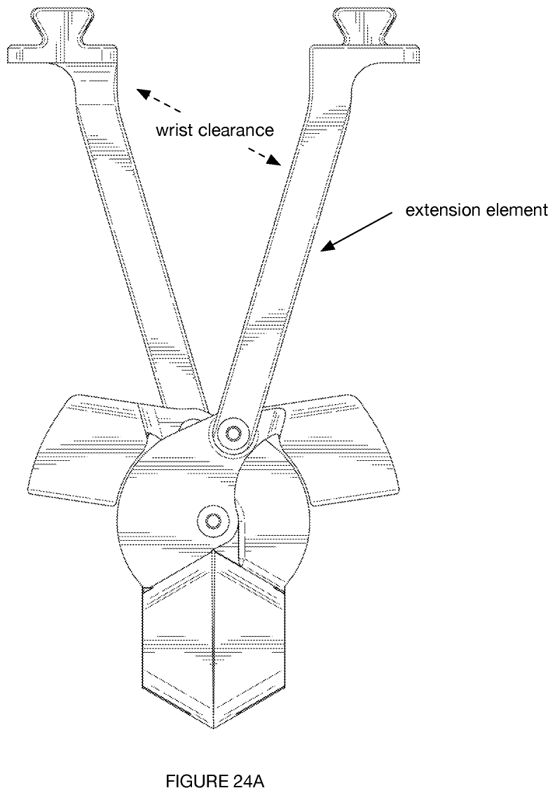

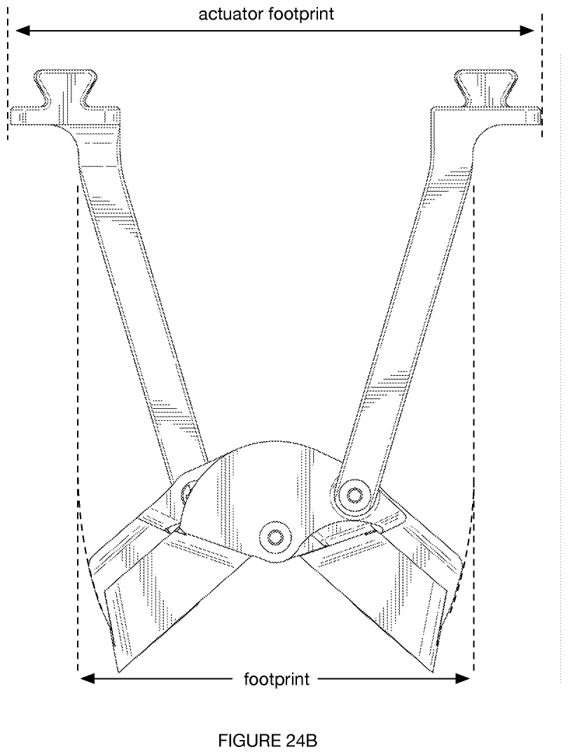

The utensil mating connector(s) can include and/or interface with an extension element(s) (e.g., examples are shown in FIGS. 12A-12B, 21A-21B, and 23A-D) which can function to physically distance the utensil from the actuator (and/or robotic assembly system). In particular, physically distancing the utensil from the actuator may advantageously distance the robot and/or end effector from the food ingredients being manipulated, reducing the potential for soiling and/or collisions. Further, physically distancing the utensil from the actuator may dissociate the physical footprint of the actuator (and/or terminal end of a robot arm; an example is shown in FIG. 24B) from the utensil, allowing food manipulation by the utensil to be unhampered (e.g., when reaching into deep containers and/or food pans) by dimensional constraints of the actuator. As an example, the extension element may facilitate utensil accesses a pick area (and/or volume) within a food container which is independent of actuator dimensions, thus allowing the use of larger actuators to achieve greater forces and/or stroke lengths (e.g., which can increase the versatility and/or efficacy of various utensils; an example is illustrated FIGS. 25A-25E). As a second example, the extension elements may allow separate bounding boxes (e.g., with separate footprints) to be utilized for the utensil and the actuator. Accordingly, in variants where the extension element increases the length of the tool to greater than a depth of a foodstuff bin (e.g., 2.5 inches, 4 inches, 6 inches, 8 inches, greater than 8 inches, etc.), the driving collision constraints can be based on the pick depth and an offset of the utensil footprint relative to the foodstuff bin wall(s), as opposed to being driven/limited by the collision box of the actuator. However, the actuator may drive various collision constraints (e.g., internal/self-collisions, etc.) and/or the utensil can be otherwise controlled based on any suitable collision constraints.

Extension elements are preferably oriented to offset the utensil along a direction perpendicular to an actuation input (e.g., relative to a direction of a linear actuation; relative to an axis of rotational actuation), but can alternatively extend in the same direction as the actuation input (e.g., for vertical-acting actuators), be angled/skewed, and/or otherwise offset the utensil from the actuator. In variants, extension elements can be oriented to offset the utensil along a direction perpendicular a mating interface and/or mating fastener (e.g., perpendicular to pinned connection, an example of which is shown in FIG. 10; perpendicular to a direction of a dovetail mate, an example of which is shown in FIG. 11; etc.). As an illustrative example, where a robot may generally execute picks substantially vertically in a “top-down” direction, extension elements may be individually or collectively oriented substantially vertically in nominal operating configurations (e.g., at time of actuator actuation, during pick execution, during insertion, etc.; with a vertically oriented V-shape), offsetting the utensil from the actuator in a vertical direction. In variants, the extension elements can be sized based on a depth of a foodstuff bin and/or maximum pick depth (e.g., which may allow ingredient picking without the actuator entering an interior volume of a foodstuff container). In a first example, the extension element(s) can offset the utensil from the actuator by: less than 5 cm, 5 cm, 8 cm, 10 cm, 12 cm, 15 cm, 20 cm, 25 cm, 30 cm, 50 cm, greater than 50 cm, any range bounded by the aforementioned values, and/or any other suitable distance. In a second example, a combined length (e.g., maximal length, in an open configuration, in a closed configuration, etc.) of the extension element and the utensil is larger than a depth of an ingredient bin. In a third example, the extension elements can have a length which is greater than an actuation distance of the actuator and/or actuation input (e.g., double, triple, quadruple, etc.; which may advantageously dissociate the physical/collision footprint of the actuator from that of the utensil and/or increase the actuation distance relative to the minimum effective linkage length at the actuation end, such as illustrated in FIGS. 25a, 25b, and 25c).

Preferably, a utensil mating connector establishes a (passive) mechanical connection between each actuation end of the actuator and the utensil (e.g., a corresponding element of a mechanical linkage thereof), but can otherwise suitably connect the actuator and the utensil. Accordingly, a utensil mating connector can include a first component mounted to the actuator (and/or integrated with the actuator), which interfaces (via the mating interface) with a second component connected to the utensil. The extension can be at the utensil side of the mating interface (e.g., an extension element can include the features defining the utensil side of the mating interface) and/or at the actuator side of the mating interface. As an example, the mating interface can be proximal to the actuator (e.g., closer to the actuator than the grasp cavity) or proximal to the utensil (e.g., closer to the grasp cavity than the actuator.

In a specific example, the utensil mating connector can include a pair of tapered dovetail joints defining substantially parallel primary axes (respective assembly directions, etc.) and retained with manual retention pins which are substantially orthogonal to the respective primary axes.

The utensil mating connector(s) and/or components thereof can be manufactured from titanium, stainless steel, aluminum (e.g., anodized), but can include any other suitable materials or material composition. The utensil mating connector(s) can be manufactured by a material removal process (e.g., wire EDM, CNC milling, etc.), but can additionally or alternatively be fabricated by casting, forming, additive material processes, and/or can be otherwise fabricated.

However, the system can otherwise include or be used in conjunction with any other suitable mating components/connector; or can otherwise exclude a utensil mating connector. As an example, the set of mechanical linkages can be directly integrated with an actuator and/or otherwise mated to an actuator.

In an example, the actuator and the utensil mating connector cooperatively define a first footprint, wherein the foodstuff utensil defines a second physical footprint, wherein a vertical projection of the first footprint extends at least partially beyond the second footprint (e.g., in one or more configurations; covering a larger area; spanning a greater length and/or width, etc.).

### 3.1 Utensil.

The utensil 200 functions to grasp and/or manipulate foodstuff ingredients within a grasp cavity to facilitate ingredient picking (e.g., from an ingredient bin) and/or insertion (e.g., into a foodstuff container). Additionally or alternatively, the end effector system can function to evacuate ingredients from the grasp cavity (e.g., clearing out ingredients adhering to the utensil). Additionally or alternatively, the end effector system can function to shape a profile of ingredients (e.g., upon insertion). The utensil can include: a set of scoops; a set of mechanical linkages; a set of ingressive elements; and/or any other suitable components. However, the end effector system 100 can additionally or alternatively include any other suitable set of components.

The utensil and/or each component thereof is preferably passive (i.e., unpowered), transforming entirely based on mechanical transformations of the actuator and/or utensil mating connector(s). For example, the utensil may include no electrical, pneumatic, or hydraulic actuators (e.g., which may facilitate cleaning by submersion, such as in a COP solution, and/or dishwashing).

The utensil and/or each component thereof is preferably constructed from a polymer material (e.g., PolyOxyMethylene [POM] a.k.a. acetal, such as Delrin° from DuPont™; thermoplastic; etc.), but can alternatively be metal (e.g., titanium, stainless steel, aluminum, etc.) but can include any other suitable materials or material composition. The utensil can include or be coated with ceramic, Polytetrafluoroethylene [PTFE], and/or another material to prevent stickage (e.g., adhesion), but can be otherwise coated/uncoated (e.g., anodized or powder coated). The surfaces of the utensil (e.g., such as the grasp surfaces, ingressive surfaces, and/or shaping surfaces) are preferably smooth and easily cleanable (e.g., in accordance with NSF requirements); however, the utensil can be otherwise textured/coated.

In variants, the utensils and/or components thereof can have an exterior appearance which is visually distinct from a set of target ingredients, which may facilitate visual identification/distinction of the utensil and foodstuff ingredients. In such variants, a color range of the utensils and/or a set of components thereof can be offset from a color of a target ingredient (or set of foodstuff ingredients) by a color distance. In an example, the food utensil and/or components thereof (e.g., scoops, ingressive elements, etc.) can be substantially blue (e.g., R:0, G:0, B:255; etc.), while ingredients/foodstuffs may be separated from the color blue by at least a threshold color distance (e.g., where the overwhelming majority of foodstuffs are not blue; where the range of foodstuff ingredients being picked are not blue; where the threshold value is predetermined minimum value). For example the scoop and ingressive elements can have at least a minimum color distance to various sets of foodstuffs (e.g., set of all ingredients, target ingredient of the utensil, etc.), which can have a value of: less than 10, 25, 50, 75, 100, 125, 150, 200, greater than 200, any open or closed range bounded by the aforementioned values, and/or any other suitable minimum color distance(s) (e.g., to enable separate visual identification of utensils and foodstuffs). For instance, blue utensils and/or utensils separated from foodstuff by at least a predetermined color distance may allow human operators and/or CV-based quality control systems to verify that no chipped/broken pieces of a utensil are present in an assembled bowl of foodstuff (e.g., as a verification/validation measure). In one set of variants, a color range of each scoop of the plurality and each ingressive element of the set satisfies a minimum color distance from an aggregate foodstuff ingredient. In an example, at least one of the plurality of scoops is blue.

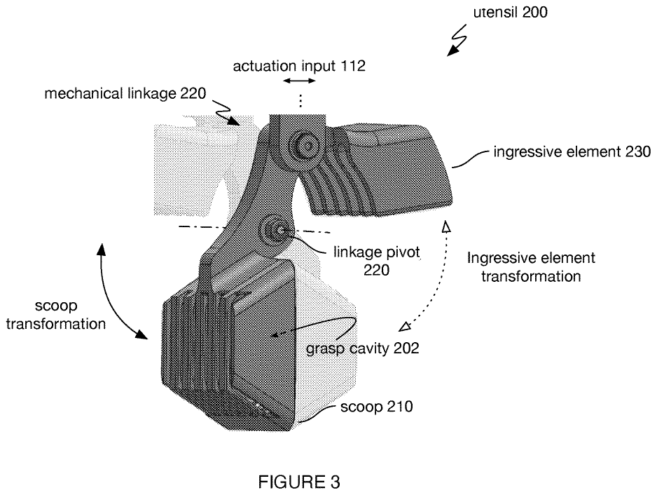

The various components (or sub-components) of the utensil can be integrated into a unitary body, or can be formed by multiple distinct bodies (e.g., which may be constructed of the same material or different materials; which may be mechanically coupled, fastened, bonded, etc.) in any suitable combination. For example, an element of a mechanical linkage may be integrated with a body of one scoop and one ingressive element (e.g., an example is shown in FIG. 3). Additionally or alternatively, a shield(s) can be integrated with the body of the scoop (e.g., a side shield along one side of a scoop; wherein each scoop of a pair of scoops may include a side shield with the side shields cooperatively closing out the sides of the grasp cavity; etc.).

The set of scoops 210 function to house, retain, and/or grasp ingredients in a grasping configuration (e.g., within a grasp volume; against a grasp surface). The set of scoops can define a grasp cavity (e.g., graspable volume of foodstuff ingredients), bounded by a grasp surface of the scoop which establishes physical contact with the foodstuff (e.g., in a grasp configuration). The grasp cavity is preferably at least partially unenclosed in a grasp configuration of the utensil. As an example, the scoops can include a set of orifices (equivalently referenced herein with the term ‘apertures’) which fluidly couple the grasp cavity to an ambient environment (e.g., air may pass through the thickness of the scoops via the orifices/apertures). The grasp surface can be uncoated/unfinished (e.g., stainless steel) or coated (e.g., ceramic coating; PTFE coating; food-compatible anodize or powder coat; etc.)

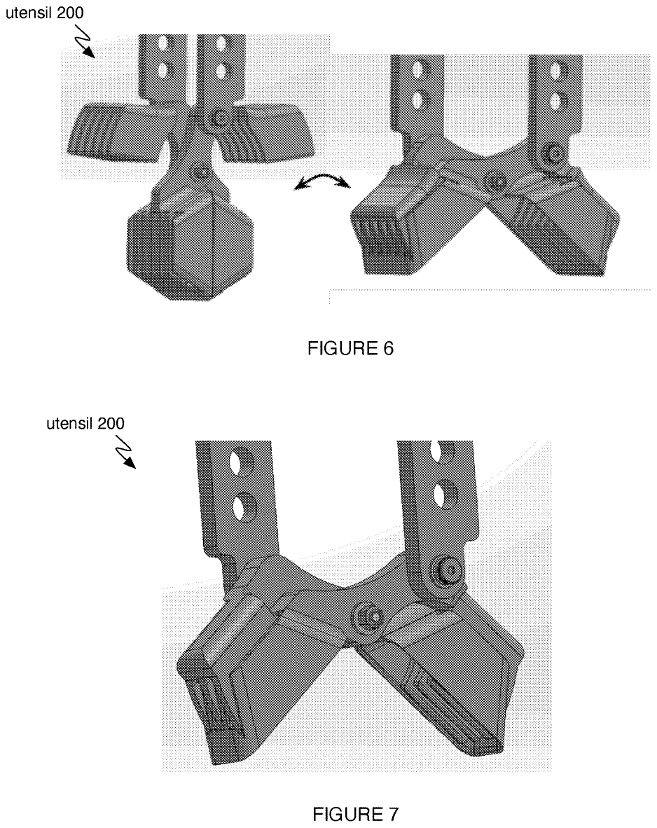

The scoops are preferably dimensioned to define a grasp cavity which may retain a predetermined amount (e.g., mass and/or volume) of ingredients. Accordingly, in various implementations, varying amounts of ingredients may be picked by: varying the actuation input and/or control of the robotic system (e.g., pick height above ingredients, etc.; controlling the effective utilization of the grasp volume) and/or by selectively interchanging the utensils based on the size of grasp volume (e.g., replacing the utensil for different desired pick amounts; utensil dimensions may be varied, such as selectively utilizing the variants of the utensil illustrated in FIGS. 6, 7, and 8).

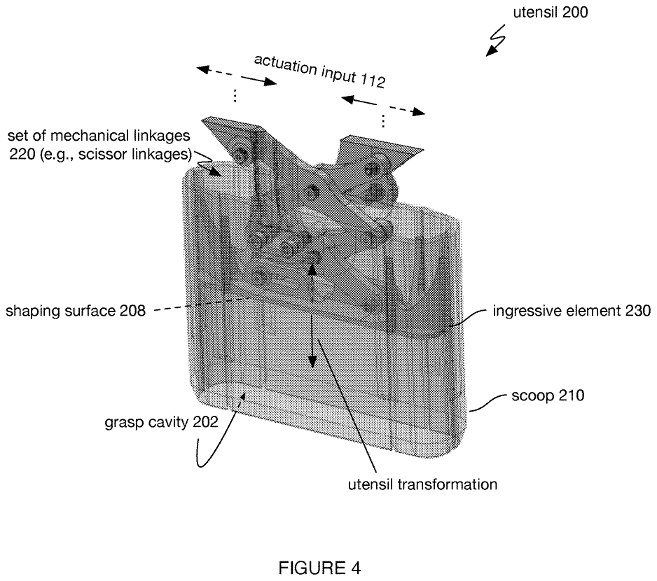

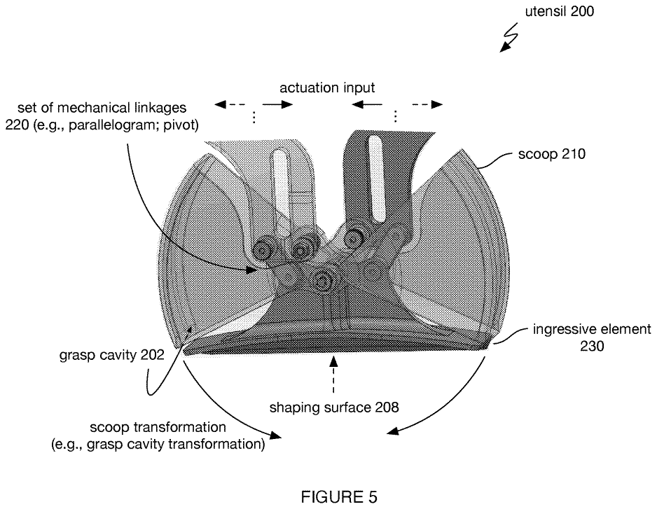

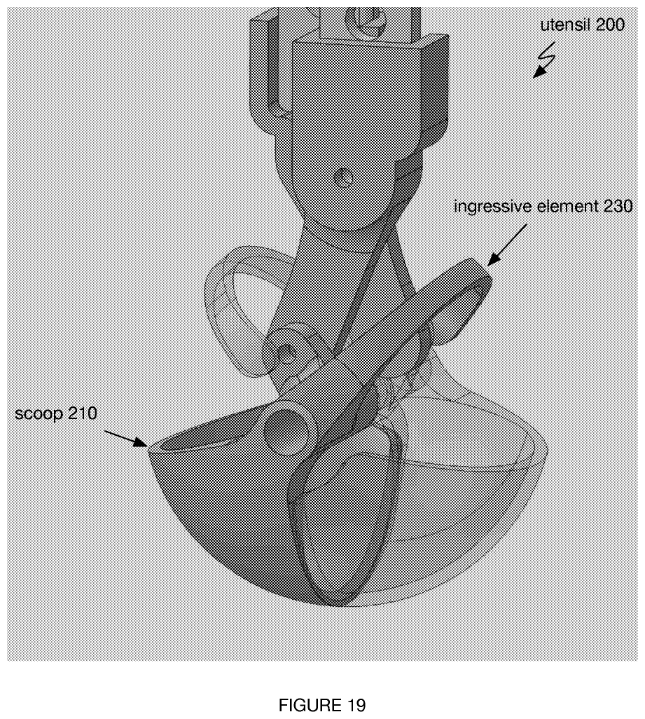

The utensil can include a singular scoop (e.g., an example is shown in FIG. 4) or multiple scoops (e.g., two, three, more than three, etc.). In one set of variants, the utensil can include a pair of scoops, such as may provide clamshell engagement (e.g., substantially symmetric, pairwise symmetry relative to a central plane). The geometry of scoops can be: clamshell-shaped, shaped a bucket of an excavator/digger, prismatic, concave (and/or include convex portions), define a substantially uniform cross section (e.g., relative to an actuation axis) and/or have any other suitable structure or geometry(ies). Likewise, the grasp cavity can be: prismatic (e.g., a hexagonal prism shape in the first configuration), cylindrical (e.g., in a first configuration), semi-cylindrical, partially cylindrical (e.g., an example is shown in FIG. 5), semi-spherical (or partially spherical; an example is shown in FIG. 19), conical, and/or any other suitable geometry(ies). In one set of variants, each scoop of the plurality is integrated with at least one ingressive element as a unitary body. In an example, the set of scoops include a first scoop integrated with a first set of ingressive elements as a first unitary body, and a second scoop integrated with a second set of ingressive elements as a second unitary body, wherein the first and second unitary bodies are substantially symmetric.

In variants, a distal portion of the scoops (e.g., relative to the actuator; opposite a structurally mounted end of the scoops) can include teeth or other extrusions/projections. Teeth can interdigitate in the second configuration and/or define a cusp-to-fossa relationship, or may be mirrored about a separation plane. Alternatively, the scoops can interface at an edge (e.g., linear, curved, etc.; an example is shown in FIG. 6). Alternatively, the scoop edges (e.g., distal edges) can be separated by a gap in the closed configuration (and/or can be actuated to partially close in some configurations, such as when grasping brittle ingredients). Teeth may function to agitate food particles (e.g., particularly large food particles, frozen food conglomerates, substantially nondeformable food particles, etc.) during actuation/grasping and/or retain food particles (e.g., when the tool does not fully close, such as may occur for non-homogeneous conglomerates and/or frozen particulates), by increasing edge length along a distal-most edge (i.e., greater edge length and surface area for agitating foodstuffs, greater edge length and surface area for retaining foodstuffs; relative to the grasp volume). However, the scoops can alternatively exclude teeth and/or be otherwise configured.

The scoops can be mounted/coupled to: the actuator (e.g., an actuated end of the actuator, a central body of the actuator), a utensil mating connector, and/or the set of mechanical linkages. In variants, the scoop may form a link and/or element of the set of mechanical linkages (e.g., an element of a 3-bar linkage, an element of a 4-bar linkage, for example; a lever arm; etc.) and thus may be integrated with the set of mechanical linkages. Alternatively, the scoop can be coupled to a distal end of a mechanical linkage (e.g., opposite an actuated end) and/or can be separate from the set of mechanical linkages (e.g., an example is shown in FIG. 4). However, the scoops can be otherwise mounted.

In variants, the scoops (and/or the grasp cavity defined thereby) can be statically mounted relative to the body of the actuator or can be actuated based on the actuation input (e.g., via the mechanical linkages). The scoops can retain foodstuff ingredients in a first (e.g., grasping) configuration by: containment/enclosure (e.g., largest orifice of scoops and/or grasp cavity is smaller than an ingredient dimension and/or characteristic length), compression/squeezing (e.g., relative pose maintained based on static friction), adhesion (e.g., sticky and/or deformable materials retained against the grasp surface of the scoops), and/or via any other suitable grasping/retention forces.

In a first set of variants, the scoop can actuatable/transformable (e.g., based on the actuation input; an example is shown in FIG. 3; a second example is shown in FIG. 5), such as a scoop, claw, and/or finger of a gripper-style utensil. In such variants, scoops can be transformed between the first configuration (e.g., grasp configuration) and a second configuration (e.g., anti-grasp configuration; ingressive configuration; open configuration, etc.) along a trajectory which can include linear transformations, rotational transformations, and/or any suitable transformations in SO(3). For example, in some variants, the scoop(s) can be transformed along a trajectory between the first and second configurations which may be parameterized as a 1-dimensional rotation (e.g., about an axis of rotation), which may minimize a resulting deformation/compression of ingredients (e.g., which may be particularly beneficial when such compressions may degrade ingredients, such as breaking cereal, etc.) for scoops geometries with substantially uniform radial geometries about the axis of rotation (e.g., an example is shown in FIG. 5 and FIG. 9). Alternatively, the transformation can include rotational and linear components (e.g., an example is shown in FIG. 6; motion may be parameterized as a minimum of 2-dimensional components; etc.), and/or can have any other suitable motion.

In a second set of variants, the scoop can be statically mounted relative to the body of the actuator (e.g., an example of which is shown in FIG. 4). In such cases, the actuator itself may be transformed (e.g., by a robotic arm and/or robotic assembly system), cooperatively transforming the actuator, scoop(s), and grasp cavity while in a first configuration. For example, the scoop may be pressed into a bin of ingredients while in the first configuration (e.g., where a transition to the second configuration forcibly ejects foodstuff from the grasp cavity).

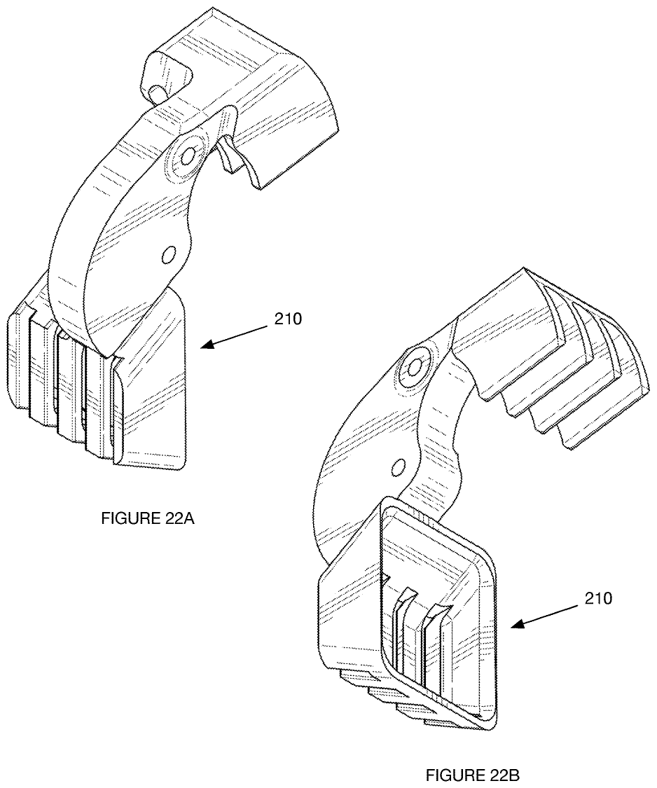

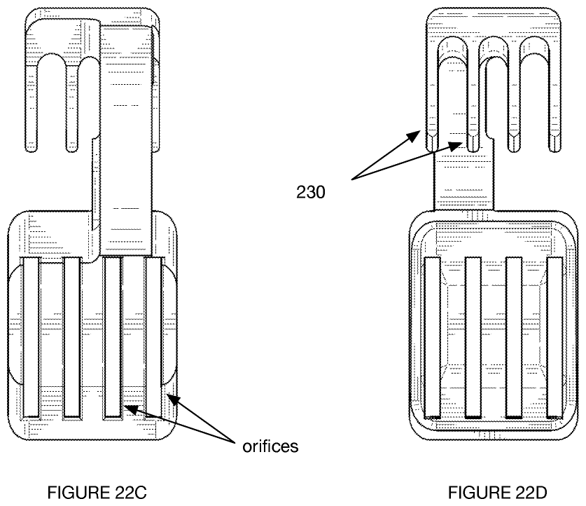

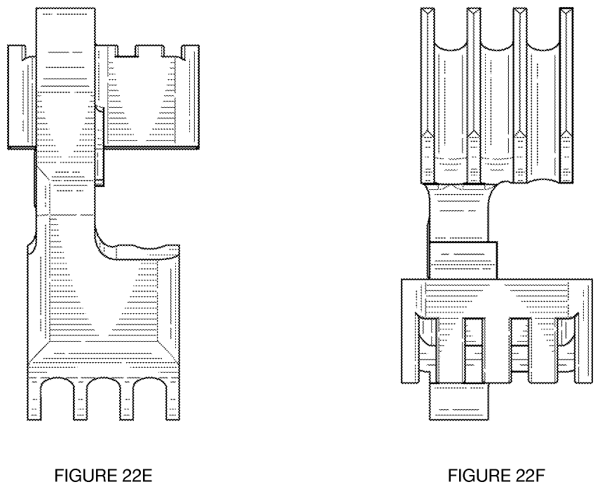

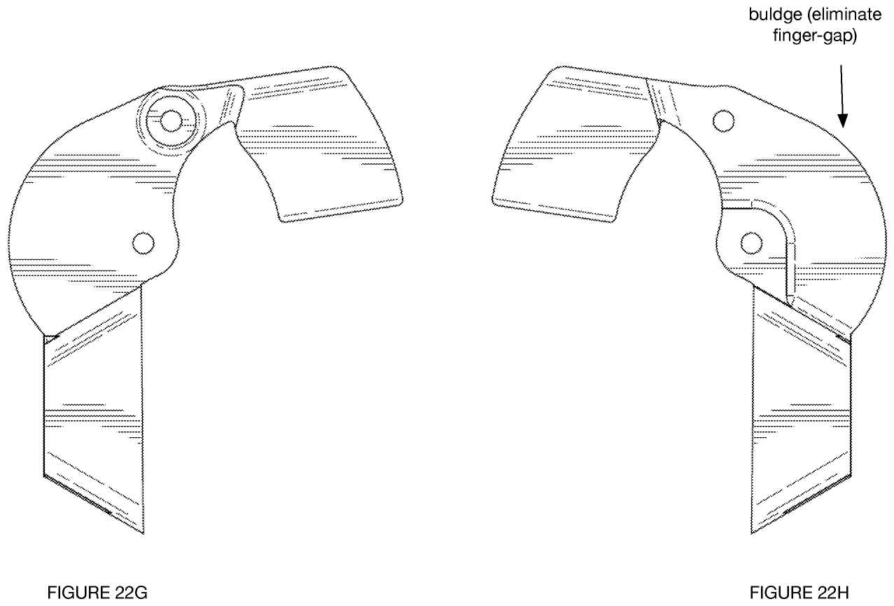

The scoops can include and/or define a set of orifices (a.k.a., apertures) which fluidly connect an interior volume and/or grasp surface of the grasp cavity to a fluid exterior (e.g., ambient air surrounding the end effector) and/or allow ingress of the set of ingressive elements into the grasp cavity in the anti-grasp configuration. Orifices can include holes (e.g., through-holes), slots, material cutouts, material voids, and/or any other suitable orifices/apertures with any suitable material cross-sectional geometries. For example, the apertures can have round/circular cross sections, rectangular cross-sections (e.g., for a projection of the aperture in a particular plane, an example is shown in FIG. 22C and FIG. 22D), open cross sections (where the aperture extends up to the distal end of the scoop, for example), and/or any other suitable cross-sectional geometries. In variants, a plurality of orifices/apertures can be arrayed (e.g., linear array, 2D array), patterned, and/or otherwise distributed. Alternatively, the orifices can be unitary (e.g., single orifice per scoop and/or per end effector), and/or otherwise arranged.

In variants, the scoop can define a forward rim 209 (e.g., a lip/edge distal from the revolute axis relative to the remainder of the scoop. In a first variant, the forward rim of each scoop can optionally touch the forward rim of the opposite scoop in the grasp configuration; alternatively the forward rims of each scoop can be separated by a gap (e.g., at the end of an actuation stroke between configurations). However, the forward rim can be otherwise configured.

In variants, the grasp volume is preferably defined as the interior volume bounded by the grasp cavity(ies) in the grasp configuration, which can be deterministic for the geometry of the tool and/or can be deterministically controlled to pick a predefined volume/amount of an ingredient(s) based on the geometry. Additionally or alternatively, the system can be dynamically/adaptively controlled according to software defined grasp parameters to selectively grasp a variable amount of foodstuff grasped by the utensil and/or scoops thereof, such as by varying actuation parameters of the actuator 110 (e.g., actuation stroke force/distance, pneumatic actuation pressure, etc.), controlling the robotic actuation of the system (e.g., based on the orientation/trajectory of the robot arm, such as by jiggling or shaking the utensil using during a grasp; based on a grasp depth below a surface of the foodstuff; based on a lateral offset relative to a foodstuff target; based on a grasp offset from a surface of the foodstuff; etc.), utilizing perception/sensory feedback control (e.g., for non-volumetric grasping, such as mass-based grasping), and/or the amount of grasped foodstuff can be otherwise controlled/adjusted during grasping and/or insertion. For example, during grasping (e.g., which may shift/agitate ingredients to facilitate grasping or grasping consistency) or insertion (e.g., which may aid in evacuation of ingredients from the grasp cavity), the actuator can be robotically manipulated to shake/jiggle the utensil and/or scoops with various amplitudes, displacements, and/or orientations (e.g., lateral displacement amplitude of less than 1 mm, 1 mm, 2 mm, 3 mm, 4 mm, 5 mm, 10 mm, greater than 10 mm, any open or closed range bounded by the aforementioned values, and/or any other suitable lateral displacement; robotic wrist rotation of: less than 5 degrees, 5 degrees, 10 degrees, 20 degrees, 30 degrees, 45 degrees, greater than 45 degrees, and/or any other suitable rotational displacement; jiggle/shake frequency of less than 0.3 Hz, 0.3 Hz, 0.5 Hz, 0.75 Hz, 1 Hz, 2 Hz, 4 Hz, 10 Hz, greater than 10 Hz, and/or any other suitable frequency; shaking/jiggling with any suitable motion characteristics, etc.).

However, the scoop can be otherwise transformable; and/or the utensil can include any other suitable set of scoops.

The set of ingressive elements 230 function to forcibly evacuate ingredients from the grasp cavity (e.g., clearing out ingredients adhering to the utensil) and/or occupy a portion of the grasp cavity (e.g., reducing the effective volume). The set of ingressive elements preferably transforms relative to the grasp cavity (and/or scoops bounding the grasp cavity) between the first and second configurations such that the ingressive element occupies a portion of the interior volume of the grasp cavity in the second (e.g., anti-grasp) configuration. Alternatively, the ingressive element can ingress into the cavity in the first configuration, between the first and second configurations, and/or in any other scoop configuration. The set of ingressive elements are preferably solid, but can alternatively be fluid (e.g., pressurized gas or liquid) and/or have any other state of matter. The set of ingressive elements can be substantially static (e.g., static, static relative to the actuator, displacement of less than 10% of a grasp cavity displacement, etc.; an example is shown in FIG. 5) or may be transformable between the first and second configurations (e.g., examples are shown in FIGS. 3 and 4). For example, the set of ingressive elements can be coupled to the same actuation input as a scoop, a different actuation input than the scoop, may be coupled to the scoop (and/or integrated into a singular body; an example is shown in FIG. 3). Accordingly, the ingressive elements may transform through the grasp cavity by transforming either and/or both of the scoop(s) and the ingressive element(s).

In the second configuration (and/or first configuration and all liminal states therebetween) set of ingressive elements are preferably offset from the body of the scoops and/or orifices thereof by a clearance distance (e.g., less than 0.25 millimeters, 0.25 millimeters, 0.5 millimeters, 1 millimeter, greater than 1 millimeters, any open or closed range bounded by the aforementioned values, etc.), which can minimize cyclic wear (e.g., for many thousands of cycles; occurring as a result of material contact under one or more instantaneous load cases and/or liminal states between the first and second configurations) during repeated and/or continuous operation. However, the ingressive element can alternatively establish contact with the body of the scoop(s) grasp surface and/or scrape against the scoops (e.g., where the material of the ingressive elements may be rubberized or deformable), or can be otherwise suitably configured.

The ingressive elements can enter the grasp cavity through orifices in the scoop(s), such as through a convex/exterior side of a scoop (e.g., opposite grasping surface), through a thickness of the scoop, parallel to a central axis of a scoop (e.g., where the radial cross section of the scoop is substantially uniform along a length of the axis), and/or at any other suitable ends. The utensil can include a single ingressive element (e.g., an example is shown in FIG. 4) or multiple ingressive elements; ingressive elements can have one-to-one correspondence with the scoops (e.g., an example is shown in FIG. 3), the utensil can include multiple ingressive elements per scoop (e.g., one-to-one correspondence per orifice in the scoops, etc.), and/or a single ingressive element may correspond to multiple scoops (e.g., an example is shown in FIG. 5).

The ingressive elements can be in the form of fins, appendages, and/or protrusions, which extend from one or more material bodies of the end effector system. For example, ingressive elements may have a structure of fin array of a heat sink (e.g., with a geometry which may increases the convective/radiative heat transfer of the body, and/or which may have minimal to no impact on the system thermals) or resemble a heat sink fin array (e.g., while being constructed from a polymer). Additionally or alternatively, the ingressive elements can include a mechanical fin(s) with a cross-sectional geometry (e.g., along a primary axis of the fin, swept along a linear/arcuate path, etc.) which is substantially geometrically similar (e.g., scaled down from, offset by the clearance distance from) a cross-sectional geometry of a respective orifice(s), which the ingressive element may penetrate in one or more configurations. As a first example, fins may be arcuate, having a first and second radius about radial section of a hinge/revolute axis 300 of the set of linkages based on proximal and distal end positions of apertures, such that the fins are configured pass through the orifices based on a relative rotation between the fins and scoops rotate about the revolute axis.

In one set of variants, the ingressive elements and the interior volume of the grasp cavities each define a respective swept volume based on a transformation of the end effector system between a grasp configuration and an anti-grasp configuration, wherein the respective swept volumes of the ingressive elements and the grasp cavities intersect.

In one set of variants, the ingressive elements occupy and/or intersect (in the anti-grasp configuration) a swept volume defined by a transformation of the scoops between a grasp configuration and an anti-grasp configuration.

In one set of variants, the ingressive elements transform along a swept volume (e.g., union of volumetric regions occupied by the ingressive elements at each liminal configuration) between the grasp and anti-grasp configurations, wherein the swept volume intersects a volume of the grasp cavity in the anti-grasp configuration.

In one set of variants, the interior of the grasp cavity comprises a grasp surface 204 which is configured to contact ingredients within the grasp cavity, wherein the grasp surface defines a reference surface, defining a maximal extent of the ingredients in the grasp configuration (e.g., where ingredients do not pass through the orifices; by substantially closing out orifices relative to the grasp surface, such as by fitting a planar/arcuate surface to the orifice based on the scoop geometry, etc.; wherein the reference surface is a closed 3D solid), wherein the ingressive elements ingress the reference surface in the anti-grasp configuration.

In one set of variants, each ingressive element defines an ingressive surface 206 (e.g., at a distal end of the fin/appendage) which is configured to contact foodstuff ingredients in one or more configurations of the system, wherein the ingressive surfaces ingress the grasp cavity in the anti-grasp configuration.

In one set of variants, each ingressive element of the set comprises a fin with a cross-sectional geometry which is strictly smaller than the geometry of a respective aperture (e.g., wherein the fin is configured to ingress the respective aperture in the anti-grasp configuration).

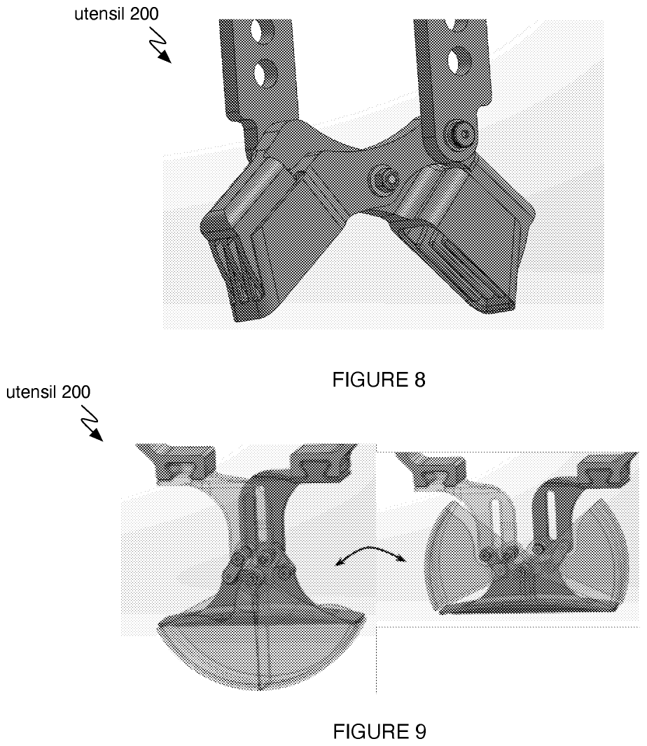

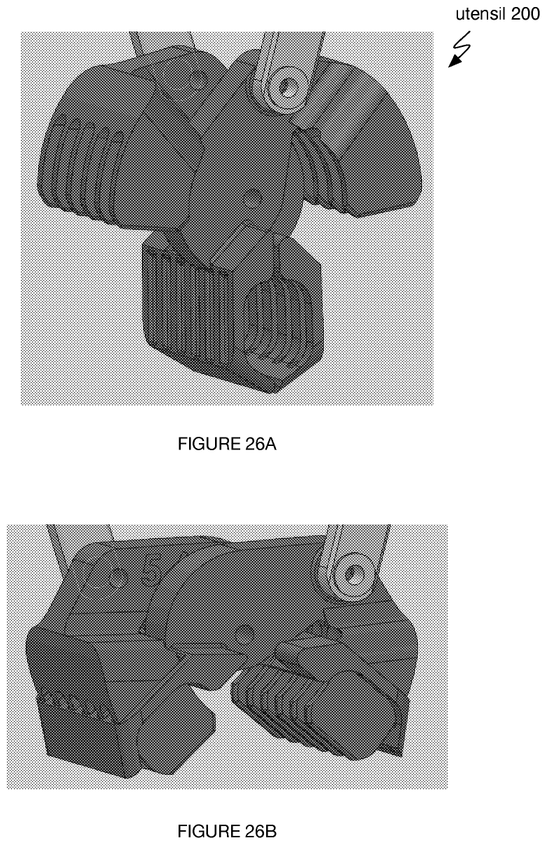

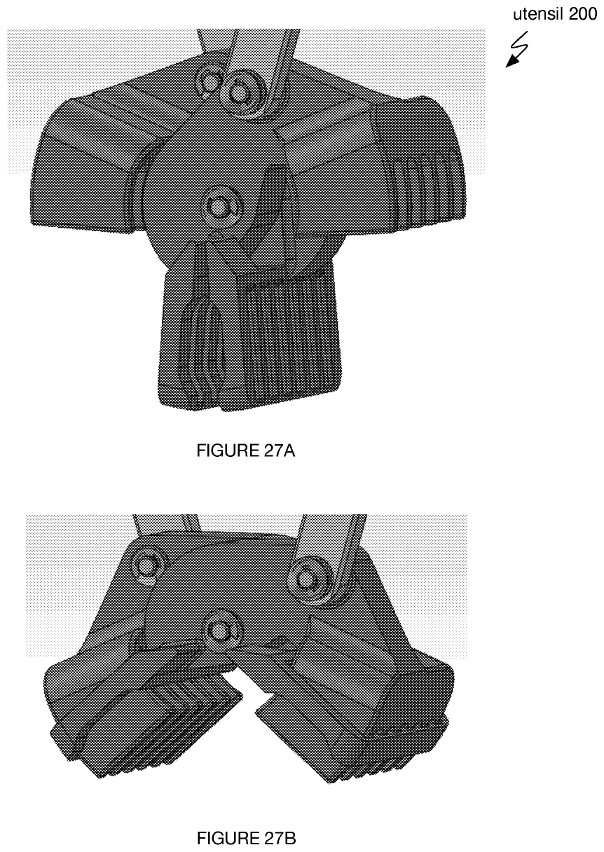

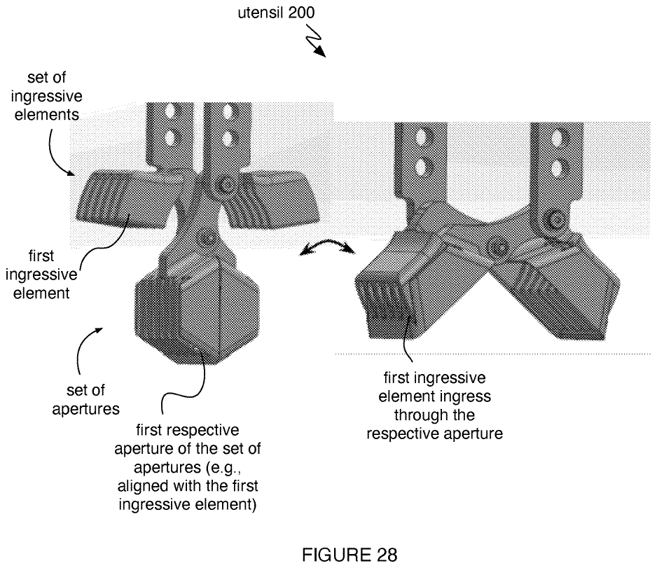

Ingressive elements can ingress a portion of the scoop and/or grasp volume (e.g., a first example is shown in FIG. 6, a second example is shown in FIG. 7; relative to a side view cross-section) or an entirety of the scoop interior (e.g., with less than a predetermined clearance of less than a predetermined dimension, such as a minimum foodstuff particulate dimension, to all portions of the scoop; an example is shown in FIG. 8; beyond cavity, examples of which are shown in FIGS. 26A-B and 27A-B). For example, the scoops can include a volumetric region which is not penetrated by the ingressive elements (e.g., non-ingress region of the interior), instead relying on gravity and/or other cleared ingredients to evacuate foodstuffs (e.g., where the ingressive elements clear foodstuff from a portion of grasp surfaces which have surface normal vectors oriented above horizontal and/or define an angle less than a predetermined threshold relative to horizontal, such as less than 10, 20, 30, 45, 70 degrees below horizontal, to which foodstuff particulates may more readily adhere). Conversely, in a first example, ingress element dimensions and/or orifice dimensions can be increased so that the ingressive elements ingress a proximal portion of the grasp cavity (e.g., upper portion, portion adjacent to a hinge, etc.).

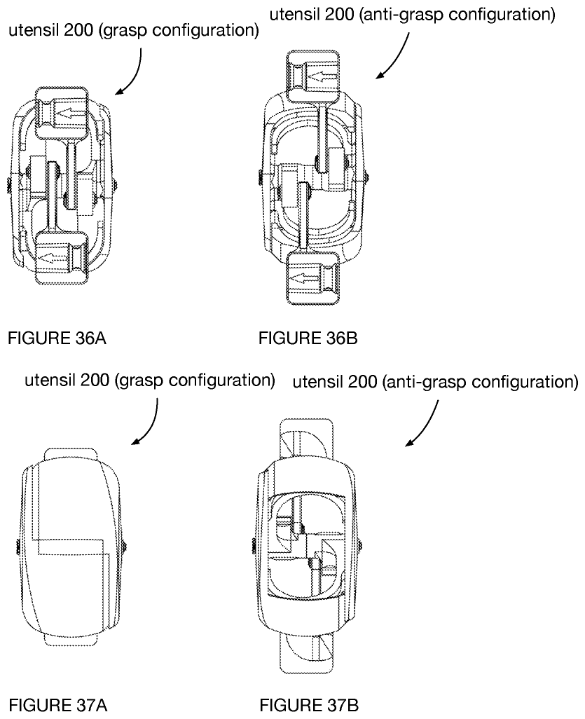

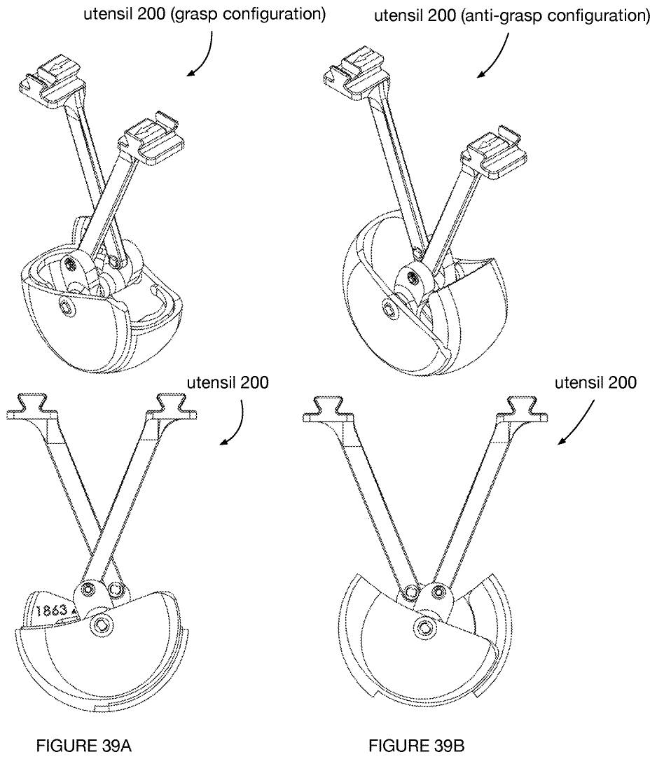

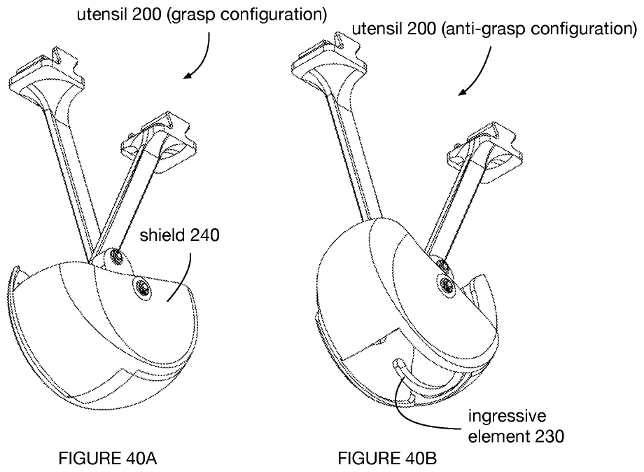

In variants with volumetric scoops (e.g., examples shown in FIGS. 36A-36B and 37A-37B; excavator style or bucket style; etc.), the ingressive element can be integrated into the scoop body as a self-ingressive scraper, wherein the ingressive element is a protrusion or ridge extending from a portion of the scoop body (e.g., from a lateral wall, from a shield, from a proximal region of the scoop) that transforms relative to the grasp surface of the opposite during actuation. The self-ingressive scraper preferably extends from a proximal region of the scoop body (e.g., adjacent to or integrated with a shield, near the revolute axis, etc.) and transforms laterally (e.g., along an arcuate path, along a path coincident with the grasp surface, etc.) across the grasp surface as the scoop transitions from the grasp configuration to the anti-grasp configuration, thereby scraping ingredients from the grasp surface. In this variant, each pair of scoops includes a pair of integrated ingressive element that evacuates ingredients from the own grasp cavity (e.g., each ingressive element evacuating ingredients from an opposing scoop, etc.). The self-ingressive scraper can define a curved or arcuate path that follows a contour of the grasp surface, a linear path, and/or any other suitable trajectory. The self-ingressive scraper can include a scraping edge (e.g., a leading edge, a distal edge) that is positioned to contact the grasp surface with a clearance distance (e.g., less than 0.25 mm, 0.25 mm, 0.5 mm, 1 mm, greater than 1 mm) or to directly contact and scrape against the grasp surface. In examples, the self-ingressive scraper can be actuated by the same mechanical linkages that transform the scoop, such that scoop rotation about the revolute axis causes the scraper to sweep across the grasp surface (e.g., example shown in FIGS. 39A-39B). This self-ingressive configuration can be particularly advantageous for liquid or semi-liquid ingredients, sticky ingredients, and/or ingredients that adhere strongly to the grasp surface, as the scraper remains in continuous proximity to or contact with the surface throughout the evacuation stroke (e.g., example shown in FIGS. 40A-40B).

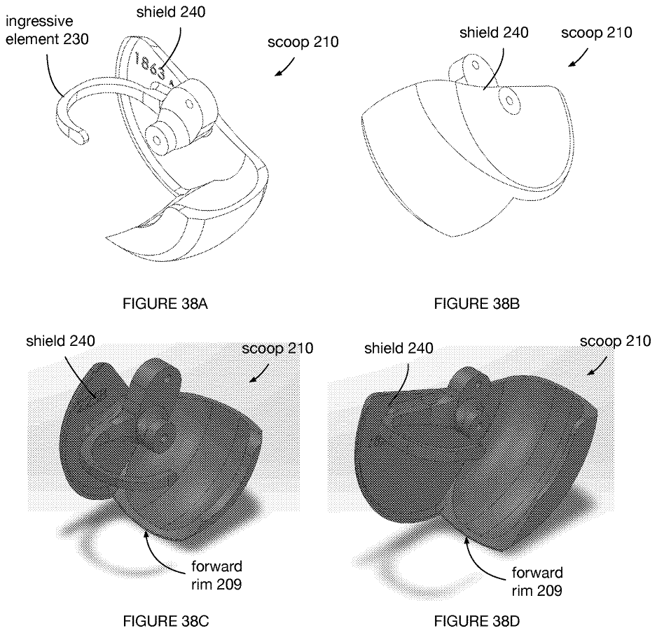

In a first self-ingressive variant (e.g., examples shown in FIGS. 38A-38D), the ingressive element comprises a curved extended element (e.g., a scraper, etc.) that extends from a proximal mounting point (e.g., on a shield, on a lateral wall, on a proximal portion of the scoop body, etc.) along a curved path toward the grasp surface. The curved extended element can define an arcuate geometry with a radius of curvature substantially matching or offset from a radius of the grasp surface, such that a distal scraping edge of the curved extended element maintains a substantially constant offset distance from the grasp surface throughout the transformation between configurations. The curved extended element can be cantilevered from the mounting point, supported at multiple points along its length, and/or otherwise structurally configured. The curved extended element can terminate at a distal scraping edge positioned to sweep across a distal portion of the grasp surface (e.g., a bottom region of the grasp cavity, where ingredients are likely to adhere due to gravity and compression forces).

In a second self-ingressive variant, the ingressive element comprises a plate (e.g., an imperforate planar blade, a panel) that extends across a width of the grasp cavity and transforms to forcibly displace ingredients from the grasp surface. The plate can be continuous (e.g., imperforate) or non-continuous (e.g., perforate). The flat plate preferably spans substantially an entire lateral width of the grasp cavity (e.g., extending from one lateral side to an opposing lateral side, spanning 80%, 90%, 95%, 100% of the cavity width), creating a pushing or bulldozing action that evacuates ingredients en masse rather than through a scraping action. The flat plate can be oriented substantially perpendicular to a proximal-distal axis of the grasp cavity, angled relative to the grasp surface (e.g., at an angle of 10 degrees, 20 degrees, 30 degrees, 45 degrees, 60 degrees, 90 degrees relative to a tangent of the grasp surface), and/or otherwise positioned. In variants, the flat plate can include a distal edge feature (e.g., a straight edge, a beveled edge, a serrated edge, a rounded edge) configured to facilitate ingredient displacement without damaging delicate ingredients. The flat plate configuration can be particularly effective for completely evacuating viscous or semi-solid ingredients (e.g., hummus, guacamole, mashed potatoes, thick sauces) that require positive displacement rather than scraping to achieve complete evacuation.

However, self-ingressive scoops (e.g., clamshell, bucket, cylindrical, etc.) can include any other suitable ingressive elements.

However, the scoops and/or ingressive elements can be otherwise shaped to provide any suitable partial or complete ingress of the ingressive elements in the anti-grasp configuration.

However, the utensil can include any other suitable set of scoops.

The set of mechanical linkages 220 function to transform the actuation input 112 from the actuator (e.g., as transferred through the utensil mating connector) into a relative transformation of the grasp cavity. Additionally or alternatively, the set of mechanical linkages functions to transition the utensil between a first configuration (e.g., grasp configuration) and a second configuration (e.g., anti-grasp configuration; ingressive configuration; open configuration, etc.).

The mechanical linkages preferably include revolute (a.k.a. hinged) joints, but can additionally or alternatively include prismatic (a.k.a. sliding) joints, spherical joints, cylindrical joints, universal joints, planar joints, and/or any other suitable joints. The mechanical linkages can be coupled and/or formed into a unitary kinematic chain, multiple kinematic chains, open kinematic chains, closed kinematic chains, and/or arranged in any other suitable configuration(s). The set of mechanical linkages can include one or more: lever mechanism (e.g., hinged linkage), scissor linkage, 3-bar linkage, 4-bar linkage (e.g., parallelogram linkage), 5-bar linkage, 6-bar linkage, planar linkage, spatial linkage, Scott Russell linkage, crank-rocker linkage, slider-crank, drag-link mechanism, and/or any other suitable linkage(s). The set(s) of mechanical linkages is preferably substantially symmetric (e.g., in a projected plane, mirror symmetry, etc.), but can alternatively be asymmetric. In a first example, a single linkage can be symmetrically connected to opposing scoops (e.g., hinged at a central pivot) and generate symmetric transformations (e.g., an example is shown in FIG. 6). In a second example, a pair of joints constraining a distal element of a scissor linkage can be a revolute joint and a pin-in-slot joint (e.g., which may be kinematically modeled as a revolute joint in combination with a sliding joint), respectively. However, any suitable types and/or arrangements of mechanical linkages can be used. However, the utensil can include any other suitable set of mechanical linkages.

In one set of variants, the mechanical linkages can define a first 2D coupler curve associated with a point on the body of the ingressive elements and a second 2D coupler curve associated with a point on the body of a scoop, wherein the first and second coupler curves intersect in a projected 2D plane (e.g., side view plane; an example is illustrated in FIG. 25E).

The mechanical linkages can be actuated linearly (e.g., extending one element/bar of the linkage, an example is shown in FIGS. 25A-25E), rotationally, and/or otherwise actuated via any suitable actuation input[s] 112).

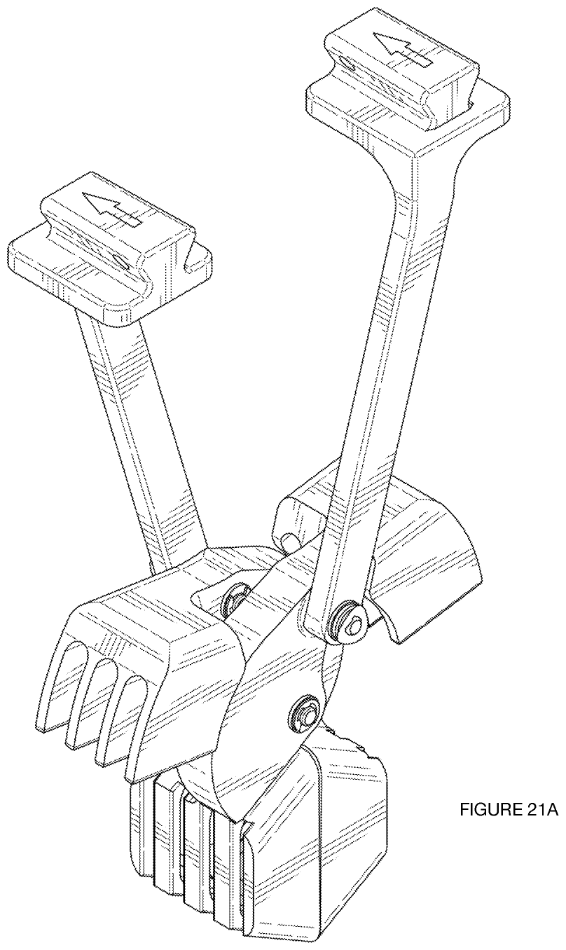

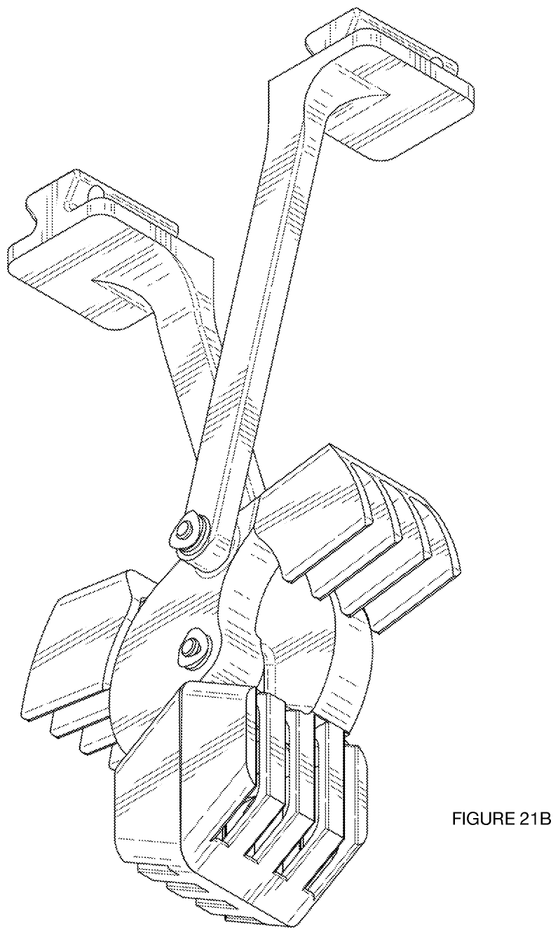

In variants, revolute joints between mechanical linkages can include any suitable hardware/fasteners. In a first example, revolute joints can include shoulder screws or other threaded fasteners (e.g., lock nuts/washers; examples are shown in FIGS. 3-9; etc.). In a second example, revolute joints can include grooved pins with retention clips (e.g., c-clips) and wave lock washers (e.g., examples are shown in FIGS. 20A-20B, and FIGS. 21A-21B).

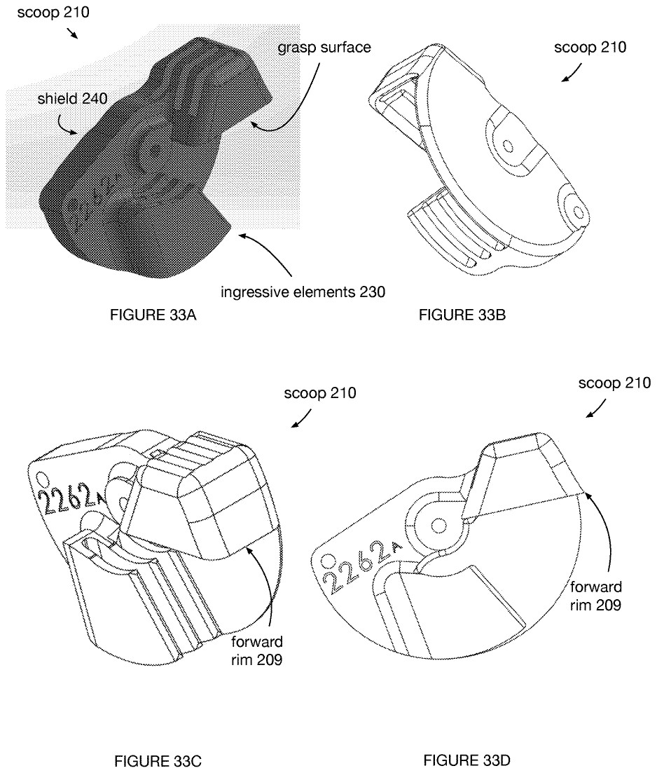

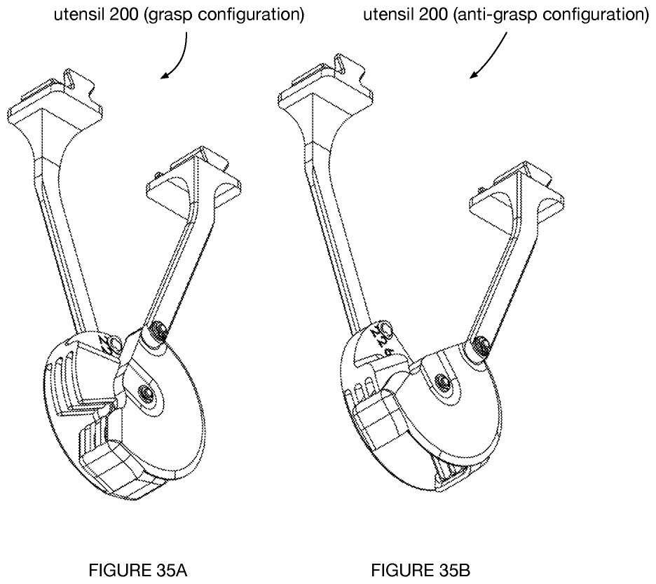

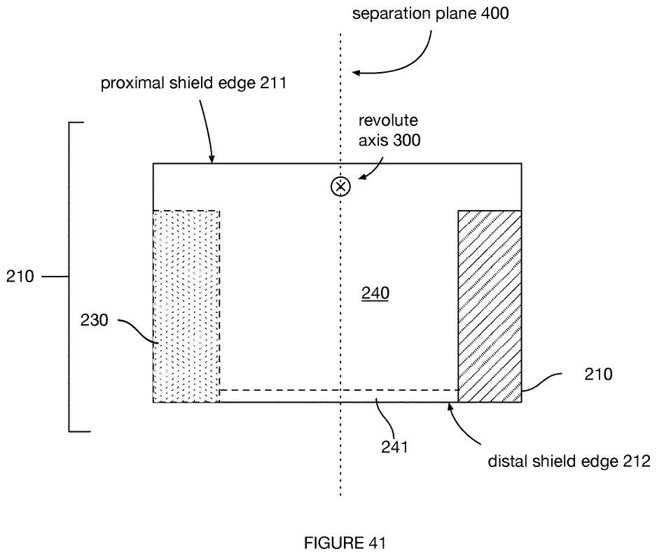

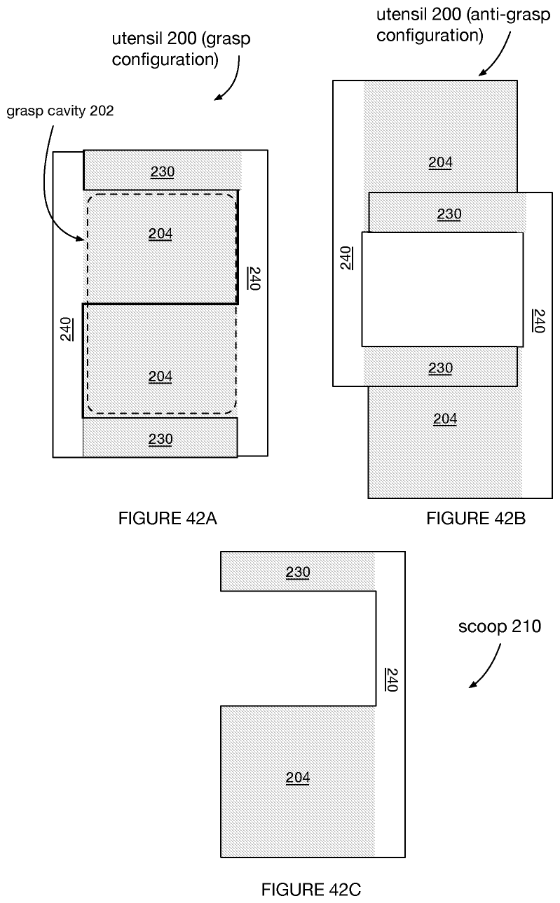

The utensil can include a set of shields 240 which function to retain foodstuff during actuation/grasping (e.g., examples shown in FIGS. 42A-42C, and 35A-35B). Each shield is preferably arranged on a lateral side of the grasp cavity (e.g., with a surface normal to the revolute axis and distal from a center of the grasp cavity); however, the shield can be in any other suitable position/orientation. Each utensil can include a single shield (e.g., defining a single lateral side of the grasp cavity while the utensil is in an anti-grasp configuration, etc.), a pair of shields (e.g., laterally enclosing the grasp cavity while the utensil is in the anti-grasp configuration, etc.; example shown in FIGS. 32A-32B), and/or any other suitable number of shields. In a first dual-shield variant, each scoop of an opposing pair of scoops includes one shield (e.g., for each lateral side of the grasp cavity; example shown in FIGS. 33A-33D). In a second dual-shield variant, one scoop of an opposing pair includes no shield, and the other scoop includes two shields (e.g., one for each lateral side of the grasp cavity). In dual-shield variants, the shields can be symmetrical or non-symmetrical across the grasp cavity (e.g., relative to a separation plane; example shown in FIG. 41.).

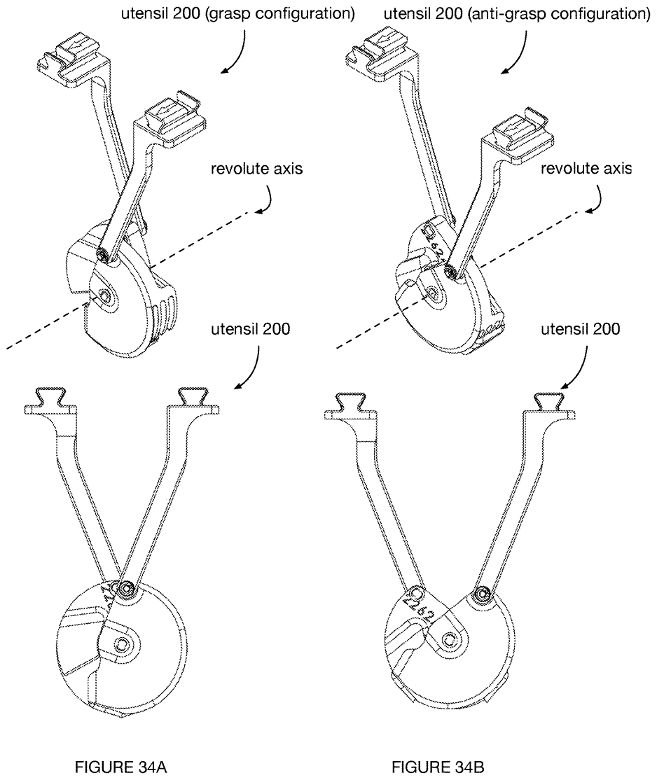

In a variant, the shield extends between a grasp surface and a set of ingressive elements (e.g., laterally retaining foodstuff through an entire grasp and/or anti-grasp stroke). In this variant, the shield can extend along an arcuate path with a center at the revolute axis 300 of the utensil (e.g., with the distal shield edge tracing an arcuate path with a center at the revolute axis; example shown in FIGS. 34A-34B). The shield can define a swept surface generated by rotating a planar profile about the revolute axis, wherein the planar profile extends from a lateral edge of the ingressive elements of the scoop body to a lateral edge of the grasp surface. In an example, the shield can define a boundary of an aperture (e.g., an orifice) of the scoop.

The shield can define a proximal shield edge 211 (e.g., an edge proximal to the revolute axis) and a distal shield edge 212 (e.g., an edge distal from the revolute axis relative to the proximal axis; example shown in FIG. 41). In a first variant, the proximal shield edge is positioned at a height equal to or greater than a proximal-most extent of the grasp surface (e.g., extending to or above the top edge of the grasp cavity when in grasp configuration). In a second variant, the proximal shield edge is positioned below a proximal-most extent of the grasp surface (e.g., terminating partway down the grasp cavity, such that the shield extends along 50%, 60%, 70%, 80%, 90%, greater than 90%, and/or any other suitable percentage of a height of the grasp surface), such that food can overflow over the proximal shield edge. In a third variant, the proximal shield edge is positioned at a height substantially aligned with a top of the grasp surface. However, the proximal shield edge can be otherwise defined.

The distal shield edge (e.g., distal from the revolute axis) of the shield can trace an arcuate path with a center at the revolute axis. In alternative variants, a distal shield edge can have a linear shape, a stepped shape, a contoured shape (e.g., conforming to a foodstuff bin geometry), and/or any other suitable shape. The distal shield edge can be oriented substantially parallel to a distal edge of the grasp surface (e.g., maintaining a consistent offset distance throughout the actuation stroke), angled relative to the distal edge of the grasp surface, and/or otherwise oriented. The shield preferably does not extend below a bottom surface of the scoop (e.g., a distal-most surface of the scoop when in grasp configuration) but can alternatively extend below the bottom surface of the scoop (e.g., extending beyond the distal edge of the scoop by 0.5 mm, 1 mm, 2 mm, 5 mm, greater than 5 mm, and/or any other suitable distance), which can provide additional lateral containment during insertion into deep ingredient bins or when picking from ingredients with high lateral flow characteristics. In an example, in the anti-grasp configuration, the lowest point of the utensil can be the distal shield edge.

The distal shield edge can optionally include a shield edge feature 241 (e.g., a taper), which functions to facilitate penetration of the shield into foodstuff during picking operations, reduce deformation or compression of ingredients (e.g., preventing smushing, crushing, or breaking of delicate ingredients), and/or minimize resistance forces during scoop insertion. The shield edge feature (e.g., taper) can define an acute angle relative to a lateral surface of the shield (e.g., less than 10 degrees, 10 degrees, 15 degrees, 20 degrees, 30 degrees, 45 degrees, greater than 45 degrees, and/or any other suitable taper angle), creating a wedge-like geometry that parts or displaces ingredients laterally as the shield enters the foodstuff. The shield edge feature can be oriented to face outward from the grasp cavity (e.g., beveled on an exterior surface of the shield), inward toward the grasp cavity (e.g., beveled on an interior surface), or include bevels on both sides (e.g., forming a knife-edge or double-bevel geometry). The shield edge feature can alternatively or additionally include: a rounded edge (e.g., with a radius of 0.5 mm, 1 mm, 2 mm, 5 mm, greater than 5 mm), a chamfered edge, a serrated edge (e.g., for cutting through fibrous or cohesive ingredients), a textured surface, and/or any other suitable edge geometry. However, the distal shield edge can alternatively be blunt, square-edged, or otherwise configured without a specialized edge feature. However, the distal shield edge can be otherwise defined.

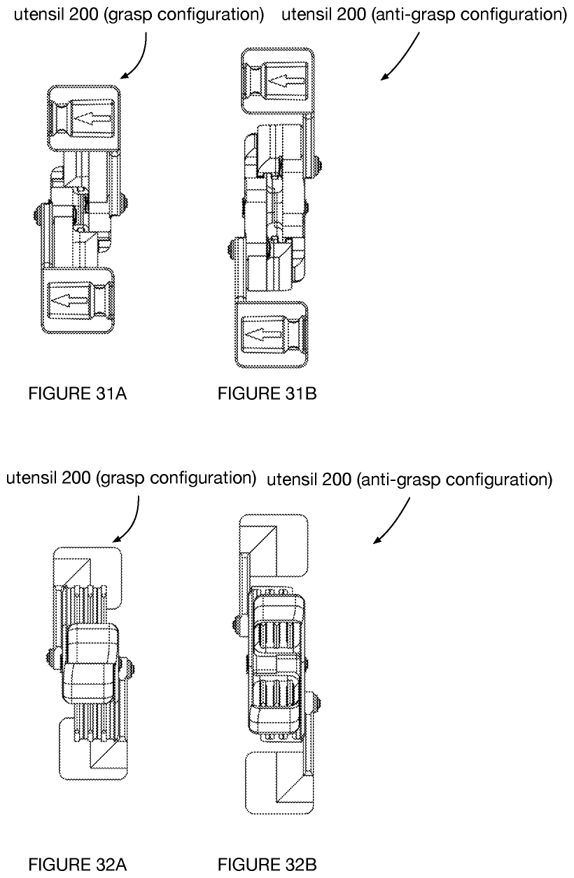

The shield preferably defines a lateral barrier that moves with the scoop during transformation between grasp and anti-grasp configurations, thereby maintaining lateral containment of ingredients throughout the actuation stroke (e.g., examples shown in FIGS. 31A-31B and 32A-32B). During a grasp/picking operation and/or an anti-grasp/insertion operation, each shield preferably slides along (with a clearance gap of zero) a laterally-outward surface of an opposing scoop (e.g., an exterior flat surface of the opposing scoop), but can alternatively be offset from the laterally-outward surface of the opposing scoop by a clearance gap (e.g., less than 0.5 mm, 0.5 mm, 1 mm, 2 mm, greater than 2 mm, and/or any other suitable clearance). The shield and the laterally-outward surface of the opposing scoop can cooperatively define a close-tolerance sliding interface that minimizes ingredient escape while allowing relative motion between the scoops. In examples, the opposite scoop (e.g., and/or ingressive element thereof) can scrape the surface of the shield during a grasp operation (e.g., thereby preventing loss of foodstuffs adhered to the shield and/or clearing ingredients from the interior shield surface). In alternative examples, the opposite scoop (e.g., and/or ingressive element thereof) can translate along the shield without contacting the shield (e.g., scraping only food near the shield). In examples, the sliding interface can be facilitated by material selection (e.g., low-friction coatings, food-safe lubricants) and/or surface treatments.). In alternative examples, no lubricants are used for the sliding interface and/or the mechanical linkages.

Each shield can be continuous (e.g., can include no orifices/apertures) thereby providing complete lateral enclosure, but can alternatively include orifices/apertures). In variants with apertures, the apertures can directly fluidly couple the grasp cavity with an external environment. In variants with apertures, the apertures are preferably sized smaller than a minimum ingredient dimension to prevent ingredient loss. The interior shield surface (e.g., surface defined on an inside of the shield, bounding the grasp cavity) can be planar, curved (e.g., convex, concave), ribbed for structural rigidity, and/or have any other suitable geometry.

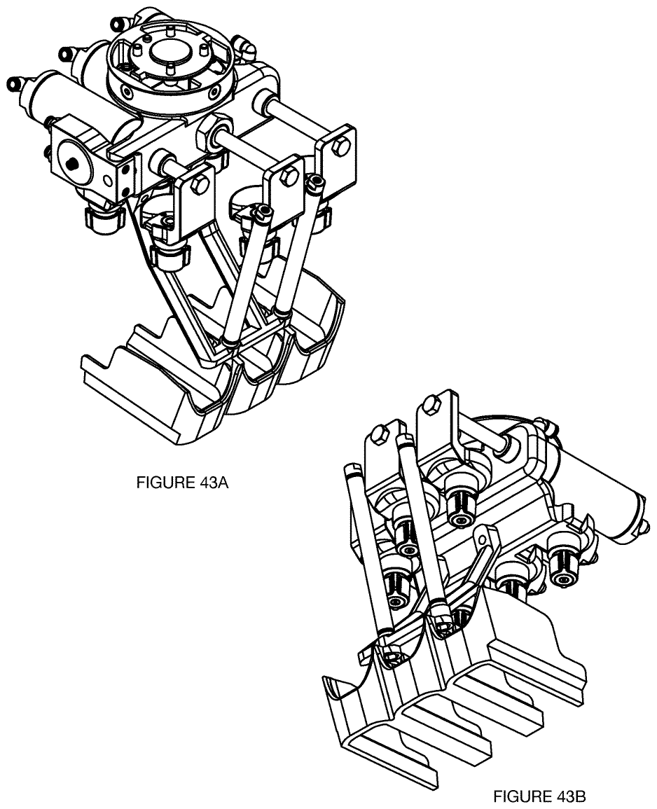

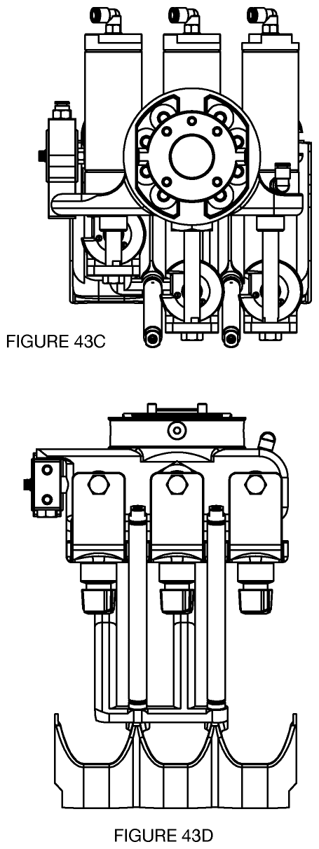

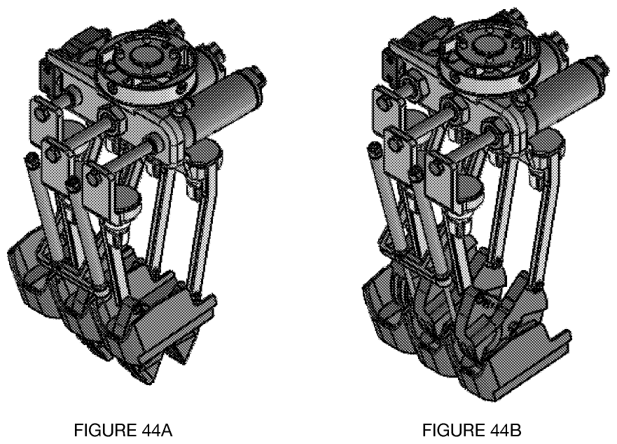

Each shield can be integrated into a scoop (e.g., formed as a unitary body with the scoop through machining, molding, or additive manufacturing) or can be separate from the scoop body (e.g., attached via fasteners, welding, adhesive bonding, snap-fit connections, or other attachment methods). In an example, a shield is a region of a scoop extending across a central plane of the utensil (e.g., a plane separating the scoops when the utensil is in the grasp configuration). Additionally or alternatively, shields can be attached to an actuator (e.g., separately from the utensil and/or shielded actuators thereof; examples are shown in FIGS. 43A-43D and FIGS. 44A-44B), base end of the mechanical linkages, and/or otherwise mounted to the end effector. For instance, separate shields may prevent loose, clingy ingredients (e.g., shredded cheese) from ejecting laterally during insertion. Shields can be actuated with the utensil, actuated separately from the utensil (e.g., an example is shown in FIGS. 44A-44B), rigidly coupled to the end of the arm, and/or can be otherwise configured. As an example, shields can funnel material from the scoops to direct insertion (e.g., to facilitate placement of loose materials into inserts, such as containers for shredded cheese).

In variants with volumetric or bucket-style scoops (e.g., examples shown in FIGS. 33A-33D), each scoop can include an asymmetric lateral configuration wherein one lateral side of the scoop includes a shield, and an opposing lateral side includes a reduced-height surface (e.g., alternatively referred to as a lateral retention surface, a lip, etc.). The reduced-height surface is preferably shorter in height than the shield (e.g., extending 20%, 30%, 40%, 50%, 60%, 70% of the shield height, and/or any other suitable percentage) and functions to retain liquid or semi-liquid foodstuffs within the grasp cavity while allowing the reduced-height surface to slide along and beneath a shield of an opposing scoop during actuation. In the grasp configuration, the shield of a first scoop and the reduced-height surface of a second scoop cooperatively define lateral containment on a first lateral side of the grasp cavity, while the shield of the second scoop and the reduced-height surface of the first scoop cooperatively define lateral containment on an opposing lateral side of the grasp cavity. During transformation between grasp and anti-grasp configurations, the reduced-height surface of each scoop preferably slides along an interior surface of the opposing scoop's shield (e.g., maintaining a clearance gap of less than 0.5 mm, 0.5 mm, 1 mm, 2 mm, greater than 2mm), creating a nested or overlapping lateral barrier that prevents ingredient escape even for highly fluid ingredients (e.g., liquids, sauces, gravies, soups, semi-liquids). The reduced-height surface can include a distal edge that is arcuate, linear, tapered, rounded, and/or otherwise shaped to facilitate sliding contact with the opposing shield (e.g., forming a sliding interface). In variants, the reduced-height surface can be positioned at a height selected to retain a predetermined volume of liquid ingredients while permitting overflow of excess liquid over a proximal edge of the reduced-height surface. This asymmetric configuration can reduce material usage and weight compared to dual full-height shields while maintaining effective lateral containment for both solid and liquid ingredients.

The shield can cooperate with the ingressive elements to define the lateral boundaries of the swept volume during transformation between configurations. In variants, a proximal edge of the shield (e.g., nearest the revolute axis) can be positioned adjacent to or integrated with the ingressive elements, such that the ingressive elements and shields cooperatively enclose the grasp cavity on all sides when in the anti-grasp configuration.

The utensil can optionally include a shaping surface 208 which functions to shape an aggregate pose of ingredients upon placement (e.g., when depressed against the upper surface of the ingredients) or picking. The shaping surface can be integrated into or be the same as an ingressive element or be a separate body. The shaping surface can be flat/planar, concave, convex, saddle-shaped (e.g., form of an anticlinal fold), and/or have any other suitable geometry. In a first example, the shaping surface can be arranged on a (downward facing) surface of the ingressive element(s), opposite the actuator. In a second example, the shaping surface can be a proximal portion of the grasp surface (e.g., closest to the actuator). In variants, the shaping surface is may be configured to compress and/or aggregate ingredients based on a transition to an anti-grasp configuration, or based on a transformation of a robotic assembly system (e.g., transforming the entire end effector system towards the ingredients in an anti-grasp configuration). However, the utensil can alternatively exclude a shaping surface, and/or can be otherwise suitably configured.

In variants, the body geometry(ies) of the extension elements, scoops, mechanical linkage elements, ingressive elements, and/or any other suitable utensil elements can be shaped to reduce/eliminate pinch points. For example, various adjacent moving components can include material closeouts which provide less than a threshold finger clearance (e.g., less than 6 millimeter spacing) between adjacent bodies which transform relative to one another. For instance, in variants where each scoop of the is integrated with a linkage element and at least one ingressive element as a unitary body (e.g., an example is shown in FIGS. 22A-22G), a central portion of the unitary body can include a uniform radius (and thickness) about an axis of the revolute joint. Accordingly, when two such bodies transform adjacent to one another (rotating about the revolute joint), the resulting transformation does not result in a gap larger than 6 millimeters (e.g., examples are shown in FIGS. 18A-18B and FIGS. 24A-24B). Additionally, in variants which include extension elements, the extension elements can be angled between a base and a distal end (e.g., rather than L-shaped), which may result in a larger clearance (e.g., for a hand/wrist) and a resulting V-shape between a pair of extension elements (e.g., which may push any foreign body caught in between them, such as a hand/wrist, upward during an actuation stroke, as opposed to instantaneously shearing the foreign body; an example is shown in FIG. 18B). However, any other elements of the system can include any other suitable bulges/protuberances which may close out finger gaps and/or otherwise reduce/eliminate pinch points. Additionally or alternatively, the utensil can optionally include or be used in conjunction with a sheath or other surrounding enclosure, which substantially encloses the utensil and may reduce/eliminate opportunities for finger/hand ingress into the set of mechanical linkages and/or base end of the scoops (e.g., which may further reduce/eliminate pinch points).

However, the end effector system can include any other suitable utensil(s).

### 4. Variants

In a first variant (e.g., examples are shown in FIGS. 6-8) a utensil can be configured to self-clean during a placement/ejection stroke. In such variants, a food ingredient manipulation utensil can be configured to work with multiple ingredient types (e.g., frozen, freshly cooked, etc.). FIG. 6 illustrates that in the closed position, food ingredients can be fully enclosed within the two opposing scoops, capturing them volumetrically; and, while in the open position, long projections can enter the scoops to facilitate the ejection of materials. Portion sizes can be carefully controlled by changing the dimensions of the utensil, such as by altering the width-an example of which is shown in FIG. 7. Additionally or alternatively, the shape of the walls can be modified, an example of which is shown in FIG. 8, which may optimize the internal volume coverage by the long projections (e.g., where the projections may span substantially a full dimension of interior cavity, such as a height). The long projections can increase the versatility of the utensil, and may allow it to function (e.g., for repeated cycles) with ingredients that might otherwise stick to the utensil surface and hinder (subsequent) picking/placement operations, such as wet ingredients or frozen ingredients that are starting to melt.

In a second variant, an example of which is shown in FIG. 9, a utensil can convert an input actuation stroke into a scooping motion; specifically, it is a scooping utensil with concentric rotation, and a stationary center of rotation. This utensil retains the previous concept of fully encapsulating the ingredients picked to achieve precise volumetric picks (e.g., within 1 mL, within 5 mL, within 10 mL, etc.). Additionally, because of the circular scooping motion with the center of the circle remaining stationary, there can be minimal (e.g., exactly zero) compression of the food ingredients outside the utensil (i.e. the remaining ingredients in the container below the volume that has been picked). This can be advantageous for delicate, soft, or easily deformable/compressible ingredients. In some examples, the utensil can include a component that remains stationary with respect to the entire motion of the scoops. In such instances, the stationary component can be located inside the scoops and aids the releasing of sticky ingredients from the inside cavity of the scoops as the utensil opens. Because the scooping motion can occur inside the actuator and utensil (vs using another method like a robotic arm), cycle time is preserved while achieving a scooping motion.

Utensils can optionally include or be used with utensil extenders (e.g., examples are shown in FIGS. 12A and 12B) which can function to physically distance the utensil from the end effector body, which may provide advantages of i) keeping the end effector farther away from the food ingredients being manipulated, and ii) dissociating the physical footprint of the end effector from the utensil, allowing food manipulation of the utensil to continue unhampered when reaching into deep containers and/or food pans. The utensil extenders can optionally include several features to reduce effective weight, and also different attachment mechanisms to the jaws of the end effectors. Extenders can allow a utensil and/or actuators to accesses a larger pick area within a food container (e.g., because of the enlarged size of the actuator necessary to achieve sufficient force and stroke length), which can increase the versatility and/or efficacy of various tools.

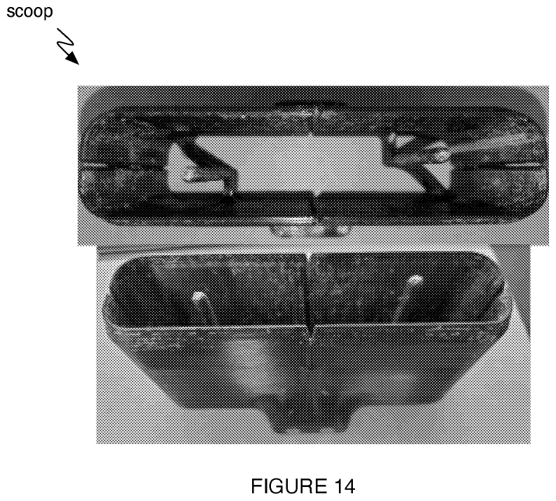

In variants, utensils can be configured to pick sticky and/or malleable ingredients (e.g., an example is shown in FIGS. 13-14). In variants, a utensil can be pressed into a container of sticky food ingredients, for example rice or ice cream, by a robotic system, causing the food ingredients to be retained within the outer cavity of the utensil. When the robotic system brings the utensil to the assigned location for food deposition, the end effector can then actuate the mechanisms within the utensil, which convert two parallel reciprocating linear motions into the downward motion of an ejection surface, as depicted in FIG. 13. The outer cavity of the utensil can include various features, such as central rods (e.g., an example is shown in FIG. 14) which can aid in the retention of ingredients by providing additional surfaces for the ingredients to adhere/stick to.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken line in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A foodstuff utensil for manipulation of foodstuff, the foodstuff utensil comprising:
a pair of scoops, each comprising:
a grasp surface;
a lip at a distal end of the grasp surface; and
a side shield; and
a mechanical linkage comprising a revolute joint, the mechanical
linkage configured to transform the scoops between a first and second configuration in which the lips are separated from each other and proximate to each other, respectively, wherein each grasp surface is between both side shields of the pair of scoops, wherein each lip extends between the side shields in both the first and second configurations.

2. The foodstuff utensil of claim 1, wherein the side shield of each scoop is substantially planar and defines an interior plane, at a proximal end of the lip, which is orthogonal to a revolute axis of the revolute joint.

3. The foodstuff utensil of claim 1, wherein each lip contacts both side shields of the pair of scoops in the first and second configurations and all liminal arrangements therebetween.

4. The foodstuff utensil of claim 1, wherein the first configuration and second configuration are at opposing ends of an actuation stroke of the mechanical linkage, which opens and closes the pair of scoops in the first and second configurations, respectively.

5. The foodstuff utensil of claim 1, wherein each scoop comprises a polyoxymethylene polymer and is configured to slide along the side shield of the other scoop of the pair during transformation of the utensil between the first configuration and the second configuration.

6. The foodstuff utensil of claim 1, wherein a side shield of a first scoop of the pair is configured to maintain a fixed distance from a second scoop of the pair throughout an actuation stroke of the mechanical linkage.

7. The foodstuff utensil of claim 6, wherein the fixed distance is zero and the side shield of the first scoop abuts the second scoop.

8. The foodstuff utensil of claim 1, wherein the side shield of the second scoop is parallel with the side shield of a first scoop of the pair and is separated from the side shield of the first scoop of the pair across a grasp cavity defined between the grasp surfaces.

9. The foodstuff utensil of claim 8, wherein in the first configuration, the grasp surface of a first scoop of the pair, side shield of the first scoop, the grasp surface of a second scoop of the pair, and side shield of the second scoop constrain foodstuff from exiting the grasp cavity.

10. The foodstuff utensil of claim 1, wherein the side shields are imperforate.

11. The foodstuff utensil of claim 10, wherein each scoop is perforate proximal to the lip.

12. The foodstuff utensil of claim 1, wherein a first scoop of the pair is configured to rotate relative to a second scoop of the pair about the revolute joint.

13. A foodstuff utensil configured to manipulate foodstuff by articulation between an open configuration and a closed configuration, the foodstuff utensil comprising:
a first and second scoop hinged about a revolute joint, the first and second scoop cooperatively defining a grasp cavity, in the open configuration, between a first interior of the first scoop and a second interior of the second scoop, wherein a first and a second lip of the first and second scoops, respectively, are separated in the open configuration and distal from the revolute joint; and
a left shield arranged along a left side of the grasp cavity, wherein the left shield is adjacent to both the first and second lips in the open configuration.

14. The foodstuff utensil of claim 13, further comprising a right shield connected to the second scoop and arranged opposite the left shield across the grasp cavity, wherein the right shield is adjacent to both the first and second lips in the open configuration.

15. The foodstuff utensil of claim 14, wherein the first scoop and left shield are integrated into a unitary body.

16. The foodstuff utensil of claim 14, wherein the left shield is tapered at a distal end relative to the revolute joint.

17. The foodstuff utensil of claim 14, wherein a distal end of the left shield is arcuate.

18. The foodstuff utensil of claim 14, wherein the left shield spans an annular sector about the revolute joint, the annular sector bounded, in a reference plane, by the first and second scoops in the open configuration.

19. The foodstuff utensil of claim 18, wherein the first scoop comprises a scraper arm, wherein the left shield extends from the first interior to the scraper arm, wherein the scraper arm is configured to scrape along the second interior throughout the articulation between the open and closed configurations.

20. The foodstuff utensil of claim 19, wherein the first scoop, scraper arm, and left shield are integrated into a unitary body.
